(19) United States
(12) Patent Application Publication
(10) Pub. No.: US 2026/0214451 A1
(43) Pub. Date: Jul. 23, 2026

(54) Systems and Methods for Explainable Edge Security for Emerging Radio Access Network Architectures

(71) Applicants: SRI International, Menlo Park, CA (US); Ohio State Innovation Foundation, Columbus, OH (US)

(72) Inventors: Phillip Andrew Porras, Cupertino, CA (US); Prakhar Sharma, Alameda, CA (US); Vinod Trivandrum Yegneswaran, Foster City, CA (US); Ashish Gehani, Atherton, CA (US); Haohuang Wen, Columbus, OH (US); Zhiqiang Lin, Columbus, OH (US)

(21) Appl. No.: 19/456,194

(22) Filed: Jan. 22, 2026

Related U.S. Application Data
(60) Provisional application No. 63/748,795, filed on Jan. 23, 2025.

(51) Int. Cl. H04W 12/122; H04L 41/142; H04L 41/16; H04W 24/08

(52) U.S. Cl. CPC H04W 12/122; H04L 41/142; H04L 41/16; H04W 24/08

(57) ABSTRACT

An example method for explainable security in a wireless network includes receiving, by a network controller, telemetry data generated by a radio access network (RAN) data plane of a network device during runtime. The telemetry data is indicative of communications between a base station and the network device. The method includes detecting, by a detection model, at least one potentially anomalous traffic sequence. The method includes, responsive to the detecting, providing the at least one potentially anomalous traffic sequence to a generative artificial intelligence (gen AI) model different from the detection model. The method includes receiving, from the gen AI model, a security assessment characterizing the at least one potentially anomalous traffic sequence, wherein the security assessment comprises a language explanation of a cause of the at least one potentially anomalous traffic sequence. The method includes providing the security assessment.

### CROSS-REFERENCE TO RELATED APPLICATIONS

This application claims priority to U.S. Provisional Patent Application No. 63/748,795, titled “6G-XSec: Explainable Edge Security for Emerging OpenRAN Architectures,” filed on Jan. 23, 2025, which is hereby incorporated by reference in its entirety.

### GOVERNMENT LICENSE RIGHTS

This invention was made with Government support under grant number 2326882 awarded by the National Science Foundation. The Government has certain rights in this invention.

### BACKGROUND

Higher generation cellular networks (e.g., fifth-generation (5G), sixth-generation (6G), or higher generation networks) have significantly impacted many sectors, including communication, transportation, entertainment, manufacturing, and healthcare. Some characteristics of such higher generation cellular networks involve their low latency and high data bandwidth. Software-defined networks provide an open platform and interoperability, and enable programmability that allows stakeholders (e.g., network operators) and researchers to configure software-defined services for the network.

### SUMMARY

This application is generally directed to a framework that seeks to automatically monitor, analyze, and explain anomalies and threats at the cellular network edge. This new framework enhances the emerging Open Radio Access Network (O-RAN) control plane with run-time analytic capabilities and explainability. A distinguishing aspect of this framework is the use of expert referencing, a coupling of lightweight unsupervised deep learning-based anomaly detection with large language models (LLMs) to first detect, analyze, and subsequently explain complicated real-world cellular threats and anomalies at run-time, based on enhanced security telemetry from the O-RAN data plane. The new system and method 6G-XSEC framework was evaluated against five (5) end-to-end cellular attacks from the literature, achieving 100% detection rate. In some embodiments, there may be LLM prompt templates for attack analysis and present qualitative results from five (5) LLMs.

The new system and method addresses two challenges faced by cellular network operators and businesses as networks evolve toward 6G. First, there is an increasing need to protect networks from sophisticated security threats that could disrupt services, compromise user privacy, or steal sensitive information. As more businesses rely on cellular networks for operations, from manufacturing to healthcare, any security breach could result in significant financial losses and damage to customer trust. Traditional security approaches rely on highly skilled experts to monitor and respond to threats, which is both expensive and time-consuming.

Second, when security issues do occur, network operators often struggle to quickly understand and explain what went wrong, making it difficult to take appropriate corrective action and maintain customer confidence. This is particularly challenging for smaller or private network operators who may not have access to security experts. The new system and method automatically detects security threats and explains them in clear terms that non-experts can understand. This is like having an AI security expert monitor the network, alert operators to problems, and explain both what happened and how to fix it, making network security more accessible and manageable for businesses of various sizes.

In a first aspect, a method for explainable security in a wireless network is provided. The method includes receiving, by a network controller, telemetry data generated by a radio access network (RAN) data plane of a network device during runtime, wherein the telemetry data is indicative of communications between a base station and the network device. The method also includes detecting, by a detection model, at least one potentially anomalous traffic sequence. The method further includes, responsive to the detecting of the at least one potentially anomalous traffic sequence, providing the at least one potentially anomalous traffic sequence to a generative artificial intelligence (gen AI) model different from the detection model. The method also includes receiving, from the gen AI model, a security assessment characterizing the at least one potentially anomalous traffic sequence, wherein the security assessment comprises a language explanation of a cause of the at least one potentially anomalous traffic sequence. The method further includes providing the security assessment.

In a second aspect, a network controller for explainable security in a wireless network is provided. The network controller includes a processor, and memory. The memory has stored thereon computer-executable instructions that, when executed by the processor, cause the network controller to perform operations. The operations include receiving, by a network controller, telemetry data generated by a radio access network (RAN) data plane of a network device during runtime, wherein the telemetry data is indicative of communications between a base station and the network device. The operations also include detecting, by a detection model, at least one potentially anomalous traffic sequence. The operations further include, responsive to the detecting of the at least one potentially anomalous traffic sequence, providing the at least one potentially anomalous traffic sequence to a generative artificial intelligence (gen AI) model different from the detection model. The operations also include receiving, from the gen AI model, a security assessment characterizing the at least one potentially anomalous traffic sequence, wherein the security assessment comprises a language explanation of a cause of the at least one potentially anomalous traffic sequence. The operations further include providing the security assessment.

In a third aspect, a system for explainable security in a wireless network is provided. The system includes a network device configured to receive radio access from a base station. The system also includes a network controller communicatively linked to the network device. The system further includes one or more processors, and data storage. The data storage has stored thereon computer-executable instructions that, when executed by the one or more processors, cause the network controller to carry out operations. The operations include receiving, by a network controller, telemetry data generated by a radio access network (RAN) data plane of a network device during runtime, wherein the telemetry data is indicative of communications between a base station and the network device. The operations also include detecting, by a detection model, at least one potentially anomalous traffic sequence. The operations further include, responsive to the detecting of the at least one potentially anomalous traffic sequence, providing the at least one potentially anomalous traffic sequence to a generative artificial intelligence (gen AI) model different from the detection model. The operations also include receiving, from the gen AI model, a security assessment characterizing the at least one potentially anomalous traffic sequence, wherein the security assessment comprises a language explanation of a cause of the at least one potentially anomalous traffic sequence. The operations further include providing the security assessment.

### BRIEF DESCRIPTION OF THE FIGURES

FIG. 1 illustrates an example cellular network, in accordance with example embodiments.

FIG. 2 illustrates an overview of an explainable edge security framework, in accordance with example embodiments.

FIG. 3 illustrates a table with example telemetry data, in accordance with example embodiments.

FIG. 4 presents a table summarizing the detection performance, in accordance with example embodiments.

FIG. 5 presents a visualization of the reconstruction errors generated by the unsupervised Autoencoder model, in accordance with example embodiments.

FIG. 6 presents an example prompt template and an example response, in accordance with example embodiments.

FIG. 7 illustrates two example cellular attack scenarios targeting the Radio Access Network (RAN) by exploiting unprotected protocol messages between a User Equipment (UE) and the network, in accordance with example embodiments.

FIG. 8 depicts a network environment, in accordance with example embodiments.

FIG. 9 depicts a protocol stack, in accordance with example embodiments.

FIG. 10 is a block diagram of an example computing device, in accordance with example embodiments.

FIG. 11 illustrates an example method for explainable security in a wireless network, in accordance with example embodiments.

### DETAILED DESCRIPTION

Existing approaches to cellular network security primarily relies on traditional monitoring tools and teams of human experts who manually watch for suspicious activities. These security teams use predefined rules to detect known threats and when problems occur, they spend hours or days analyzing technical logs and data to understand what went wrong. This approach has worked for years but requires expensive, highly skilled security experts who are increasingly hard to find and retain. Smaller network operators often cannot afford dedicated security teams, leaving them vulnerable to attacks.

Existing industry approaches have several significant limitations that make it increasingly inadequate for modem networks. First, it can detect known types of attacks, leaving networks vulnerable to new threats. Second, the analysis process is slow and labor-intensive, meaning problems often go unaddressed for extended periods while experts try to understand them. Third, the complexity of cellular networks makes it difficult to explain security issues to non-technical stakeholders, creating communication gaps between technical teams and business leaders. As networks become more complex and support more connected devices, these limitations become more problematic, especially for newer open network architectures that may introduce additional security vulnerabilities.

The system and method described herein, termed explainable edge security framework (6G-XSEC), is an integrated system that monitors cellular network traffic, automatically detects security threats, and provides clear explanations of what may be happening. It works by collecting detailed security data from the network, using AI to identify suspicious patterns, and then employing large language models to analyze and explain any detected threats. In some embodiments, this new system and method works with modern open radio access networks (O-RAN), which are becoming increasingly common in cellular deployments. A significant innovation is combining automated threat detection with the ability to explain security issues in human-understandable terms.

The framework addresses existing problems through three technological innovations. First, it enhances network monitoring by collecting more detailed security-related data than traditional systems. Second, it uses advanced AI models that can learn what network traffic typically looks like and automatically detect anything unusual, and not have to rely on examples of attacks for training. This means it can detect new, previously unknown threats. Finally, it uses large language models to analyze detected anomalies and provide clear, human-readable explanations of what may be happening and why it might be dangerous. This combination of technologies eliminates a need for constant expert human analysis and makes security monitoring more accessible to organizations that lack large security teams.

Integration into 5G networks works because the framework is built to work with the O-RAN architecture already being adopted by many 5G deployments. The system installs as a set of software modules (called xApps) that run on the network's existing control computers. These modules tap into network interfaces to collect data, and they operate alongside other network management software and reduce disrupting operations. The testing demonstrated that the framework successfully detected significant attacks in their trials while generating fewer than 10% false alarms, demonstrating that it can work effectively in real-world conditions. This means network operators can add this security capability to their existing 5G networks without significant infrastructure changes or disruptions to service.

One aspect of the new system and method is “expert referencing,” which combines two AI technologies in a novel way to create an automated security expert system. This approach pairs lightweight unsupervised anomaly detection (which spots unusual patterns) with large language models (LLMs) to analyze and explain security threats in real-time. What makes this concept innovative is that it separates the detection and analysis tasks—using simple, efficient AI models for continuous monitoring while engaging more resource-intensive LLMs when potential threats are detected. This is particularly noteworthy because it is the first documented use of LLMs for explaining cellular network security anomalies, and it demonstrates that these models can effectively “think” like security experts when analyzing network behavior. This combination can achieve both high accuracy in threat detection and provide human-understandable explanations without requiring constant human expert involvement or extensive attack data for training.

The new system and method could significantly impact the cellular network business world by enabling more robust and automated security measures. This impact could be measured in several ways. First, by analyzing the reduction in successful cyberattack countermeasure and fault remediation time (i.e., remediation speed). This could include an ability to respond and recover from such incidents, and potentially reducing network down time and reducing Operational Expenditure (OpEx) remediation costs when a device encounters an error or distress. Second, with AI-informed tools for spotting problems, the system may, over time, lead to measurable reductions in the number of new incidents, due to the ability to rectify configuration mistake and deploy better security policies. Third, enhanced security measures would lead to a more stable and reliable network, resulting in better user experience, increased customer satisfaction, and fewer complaints from network users.

There are many advantages to the system and method described herein.

Enhanced Threat Detection: The combination of unsupervised anomaly detection and LLM-based expert referencing promises to detect a wider range of threats, including both known and novel attack types. This comprehensive approach would bolster network security, reducing the risk of successful cyberattacks.

Faster Incident Response: By automating threat detection and analysis, 6G-XSec aims to accelerate incident response times. The ability to quickly identify and understand security events allows for faster mitigation, reduces service disruptions and potential damage.

Improved Explainability: Leveraging LLMs for expert referencing offers a way to make complex security incidents more understandable. This improved explainability helps network operators take informed actions and provides valuable insights for strengthening network defenses.

Automated Network Responses: The framework's potential for integrating with automated network control mechanisms could lead to self-healing networks capable of automatically responding to security threats and implementing countermeasures.

Overall, there are advantages in terms of improved security, faster response times, and better explainability could be substantial for cellular network operators.

Software-defined networks enable services that may be configured to secure a network. Due to the availability of inexpensive commercial-off-the-shelf (COTS) software-defined radios (SDRs) and open-source cellular software stacks, there is a relatively low economic and technical barrier for adversarial attacks in such networks. Attacks may include, for example, employing a malicious network device, fake base stations, and/or Man-in-the-Middle (MiTM) attacks. Such threats can trigger service outages, privacy leakage, and quality-level downgrades, thereby compromising the security, privacy, and availability of the network for end-users.

Detecting and/or defending against such attacks can be a challenging task as the attacks may operate on cellular control messages, such as, for example, the layer-3 (L3) protocols such as session establishment protocols (e.g., Radio Resource Control (RRC)) and device authentication in mobile protocols (e.g., Non-Access Stratum (NAS)). Such attacks generally leverage the vulnerabilities in earlier generations of cellular protocols and continue to be applicable to higher generation cellular networks. Some existing approaches address a subset of these attacks from either the network device side or the network side. Such approaches are generally based on a limited view (e.g., network device-centric defenses cannot detect radio access network (RAN)-targeted attacks) or poor extensibility (e.g., network-based solutions with static defense mechanisms).

Software-defined networks are generally configured to disaggregate the control and data management functions of the cellular network into layers, such as (a) a network layer that provides the base-station functions of radio frequency (RF) transmission, link establishment and authentication, and data flow management, and (b) a control layer segregated to a centrally governed cloud ecosystem that provides a vendor neutral framework for integrating control and management functions for one or more base stations. Software-defined networks may be configured to support cell stations and/or base stations that can be modularly decomposed into a Radio Unit (RU), Data Unit (DU), and Control Unit (CU). The design features of software-defined networks facilitate a modular extension of the data plane's CU and DU with a security service component that may be configured to perform a fine-grained audit of the network communications between the CUs, DUs, and base stations, as well has operational aspects of the network devices. Also, for example, software-defined networks may include application programming interfaces (APIs).

For example, the security service may be configured to collect data from the network layer, generate a telemetry stream, and enable a modular extension of the control layer functions with new xApps capable of monitoring the cellular network, detecting anomalous activity, and/or mitigating such anomalous activity. This may include a wide range of attacks that directly target communications between network devices and base stations. This can enhance the reliability and resilience of higher generation cellular networks against a wide range of attacks and anomalous activity. Also, for example, runtime detection of malicious network devices (e.g., network devices that attempt to interfere in the operations of the base station), and attacks from external transmitters (e.g., transmitters that attempt to disrupt or hijack communications between the base station and the network devices) may be achieved.

For example, a software-defined radio access network (SD-RAN) from the Open Networking Foundation (ONF) implements a cloud-native RAN intelligent controller (RIC), an xApp development environment and a set of xApps for controlling open RAN elements such as logical nodes (e.g., RU, DU, and CU). In some embodiments, the RIC may be a near real-time RIC (nRT-RIC). As described herein, a data-plane security service for software-defined networks may be configured to enable control plane (e.g., xApp) security services to counter a wide range of adversarial models against the cellular networks. For example, an E2 service module (E2SM), referred to herein as a security service module (SecSM), may be introduced into the SD-RAN reference implementation for the ONF. SecSM may be configured to generate an E2T event stream, referred to herein as a telemetry stream or MobiFlow. MobiFlow may be configured to capture connection state attributes between a network device and a base station (e.g., gNodeB), and gNB statistics, to drive advanced security focused xApps and rApps.

The design of some software-defined networks separates the control plane (also referred to herein as a control layer) that manages network topology, from the data plane (also referred to herein as a network layer) that performs packet processing and forwarding. Such software-defined networks have programmable components. For example, the control plane logic may be integrated into a RAN Intelligent Controller (RIC), which can serve as a standalone programmable component to manage the RAN nodes. Also, for example, custom application-layer services, such as performance measurement and traffic steering applications, may be developed as “plug-n-play” xApps on the RIC. They may be associated with E2 service models (E2SMs) that provide support for communications with RAN nodes. Based on such an example design, sophisticated analytics may be integrated as xApps into the RIC for a variety of network monitoring and control functions. Although some of the description herein may be provided in the context of an open radio access network (O-RAN), this is for illustrative purposes only. The techniques described herein may be applicable to a higher generation software-defined network, and a 6G O-RAN is to be considered as a particular example.

For example, the framework may include plugins and xApps that augment the data plane and the control plane. An audit stream, such as MobiFlow, may be configured for fine-grained monitoring, analysis, and/or detection of potentially anomalous activities. MobiFlow may be generated by a network compliant secure service module (SecSM). Network packets may be aggregated into flow records during network transmission. Subsequently, the flow records may be converted into packet-level telemetry streams. An xApp, such as MobiExpert, may be configured based on a programming language (e.g., a Production-Based Expert System Toolset (P-BEST) language). For example, MobiExpert may be configured with programmability that enables network operators to tailor production rules to monitor, analyze, and/or detect anomalous network activity comprehensively, and with a high degree of precision.

### Example Cellular Networks

Cellular networks are the backbone of modem wireless communication, impacting numerous sectors from transportation and entertainment to manufacturing and healthcare. In recent years, the 5G/6G cellular standard and associated technologies have grown rapidly and gained widespread deployment. It is envisioned that 6G networks will revolutionize from connected things to connected intelligence with ubiquitous Artificial Intelligence (AI). This transformative leap can enable advanced capabilities such as self-diagnosis, optimization, fault recovery, and threat mitigation, thereby enhancing network performance and trustworthiness.

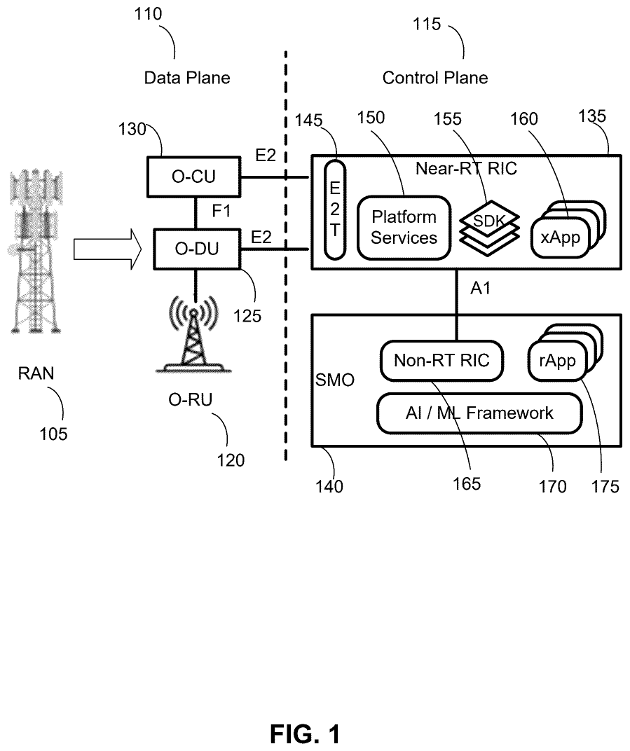

The drive toward an intelligent 6G network is fueled by several factors, including network performance upgrades and the widespread integration of AI and machine learning (ML) technologies. A significant revolution among these is the software-defined network architecture known as Open RAN (O-RAN), which introduces unprecedented programmability to traditional cellular infrastructures. O-RAN transforms the previously monolithic cellular network into a disaggregated and interoperable mobile network architecture, as shown in FIG. 1. This architecture incorporates principles from software-defined networks, allowing for modular design and the deployment of “plug-n-play” cellular control-plane applications (xApps) that perform dedicated tasks such as network monitoring and management. While much of the prior R&D has focused on network optimization and automation, the programmability of O-RAN also creates new opportunities in the security domain to enhance the resilience and trustworthiness of both public and private 6G networks.

In recent years, the mobile security community has uncovered numerous attack surfaces and exploits. These vulnerabilities are generally inherited from prior generations (e.g., LTE), and can be readily exploited with commodity hardware and open-source cellular stacks to compromise the security and privacy of network infrastructures and users at the edge. Examples of attacks include denial or disruption of cellular services at base stations, leakage of user's location and identity, and network security down-grade. To ensure security at the 6G edge, ideal solutions may rely on analytic capabilities and explainability. Effective cellular edge analytics refer to detection capabilities for current and unseen and evolving threat patterns and variants. Moreover, explainability, i.e., the ability to explain why there is an attack, is also significantly helpful for network operators to understand root causes and take corresponding actions, which also increases the network's trustworthiness.

An AI-driven and explainable edge security framework, namely 6G-XSEC, for the O-RAN architecture is described herein. This framework involves novel data-plane and control-plane extensions (e.g., xApps), enabling the network with advanced capabilities to monitor, analyze, and explain runtime anomalies and threats. For example, the framework extends the O-RAN data plane with security-aware telemetry that captures significant features for cellular threat monitoring. Also, for example, the framework employs lightweight unsupervised anomaly detection models to recognize deviated patterns representing potential anomalies or attacks. Further, the framework references expert large language models (LLMs) to provide in-depth analysis of anomalous traffic patterns. The framework appears to achieve 100% detection rate for five (5) types of unseen cellular attacks and also explains why these threats deviate from benign traffic. The framework may also be configured to enable lower-skilled and private cellular operators to rapidly detect, diagnose, and recover from runtime faults and attacks, driving toward the goal of explainable AIOps in future-generation networks.

FIG. 1 illustrates an example cellular network 100, in accordance with example embodiments. Cellular networks generally include entities such as network devices (e.g., user equipment (UE)) that may subscribe to an operational network through a Universal Subscriber Identity Module (USIM), a gNodeB, or base station (BS), located within the Radio Access Network (RAN) 105, which connects the UE to the operator's network, and a core network (CN) handling services such as authentication and agreement. CN is the mobile network backend connecting users to the external Internet. RAN 105 represents the physical cellular tower and antennas.

The term “network device” as used herein may include any device that may be configured to connect to and/or operate within a network. For example, a network device can include an unmanned autonomous vehicle (UAW), a semi-autonomous or autonomous vehicle, an internet-of-things (IoT) device, a smartphone, a wearable device, a camera, or any other mobile device, or wired device. Also, for purposes of illustration, a network device is also referred to herein as a user equipment (UE). In general, network devices are to be understood to include user equipments along with other devices.

The Open RAN (O-RAN) architecture follows 3GPP's functional split to divide the monolithic RAN design into logical components that include a data plane 110 and a control plane 112. The data plane 110 includes the Radio Unit (O-RU) 120, Distributed Unit (O-DU) 125, and Central Unit (O-CU) 130, as shown in FIG. 1. The O-RU 120 is a radio hardware deployed in the front-haul network, responsible for handling layer-1 (L1) physical radio signals from nearby user equipment. The O-DU 125 is a logical component hosted at the network edge, managing layer-2 (L2) functions such as Media Access Control (MAC). O-DU 125 handles real-time L2 functions and some low-level Physical (PHY) functions. O-DU 125 connects to the O-RU 120 and O-CU 130. The O-CU 130 handles higher-level Layer 3 (L3) protocols like the Radio Resource Control (RRC). The O-CU 130 connects to core network (CN) functionalities, such as the Access and Mobility Management Function (AMF) and the User Plane Function (UPF) of the 5G core. The O-RAN data plane 110 components communicate through standard and open interfaces, such as F1 connecting O-DUs and O-CUs. Both the O-CU 130 and O-DU 125 connect to the Control Plane 115 (e.g., Near-RT RIC 135) via E2 interfaces, enabling telemetry reporting and control.

The control plane 115 of O-RAN is separated from the data plane 110 based on the Software-Defined Networking (SDN) principles. The O-RAN control functions are implemented in Near Real-time RAN Intelligent Controllers (nRT-RICs) 135, which act as control service proxies connected to the RAN via the E2 interface. E2 Termination (E2T) 145 is the entry point for E2 messages from the data plane 110. The nRT-RIC 135 hosts various modular xApps 160 that implement customized network management functions such as monitoring, analytics, and control. Platform Services 150 and SDK 155 support infrastructure for xApps 160.

Interactions between the control plane 115 and data plane 110 may be defined by four basic E2 primitives: report, insert, control, and policy. To interact, an xApp can define E2 Service Models (E2SMs) as function-specific protocols by using these E2 primitives, based on the generic E2 Application Protocol (E2AP). For example, the O-RAN Alliance has demonstrated several exemplar E2SMs for performance monitoring and network slicing management. O-RAN also defines different latency requirements. The control loop of a nRT-RIC 135 may be configured to complete within ten (10) milliseconds (ms) to one (1) second (s), while time-insensitive tasks, e.g., ML model training, may be handled within the Service Management and Orchestration (SMO) framework 140 by applications rApps 175 running in the non-real-time domain on non-real-time RICs 165. SMO 140 is responsible for non-real-time management (time scale >1 s) and orchestration. AI/ML Framework 170 is the infrastructure for training machine learning models that can be deployed to the RICs. The AI Interface is the interface connecting the SMO/Non-RT RIC 140 to the Near-RT RIC 135 for policy guidance.

### Example Cellular Threat Landscape

Generally speaking, adversaries at the network edge attempt to compromise devices and infrastructure through the open wireless interface. These adversaries exploit vulnerabilities in cellular protocol standards by transmitting, flooding, and hijacking unprotected protocol messages over the air, while still adhering to cryptographic protections. This threat model is highly practical because adversaries can use readily available software-defined radios (SDRs) that work with open-source cellular software stacks, allowing them to easily program and execute malicious attack logic. Generally, there is an assumption that the internal components and communication in the networks, including the base stations, the core network, and the O-RAN control plane, are trusted.

### Anomalies Exhibited by Attacks

To detect and counter the aforementioned attacks, a natural solution is to inspect anomalies from the cellular traffic, as the attack traffic likely involves highly unusual traces and payloads. Two example attacks are described as to how they manifest deviated anomalies from expected cellular traffic.

One class of attacks demonstrate univariate anomalies. For example, a benign cellular trace along with another trace representing an identity extraction attack may be used by Man-in-The-Middle (MiTM) attackers. In such an attack, the adversary overwrites the downlink authentication request message to maliciously ask the victim UE to transmit its identifier in plain text. Since the identifier is bound to a specific user's SIM, this step allows tracking of the victim's location. This sequence exhibits an out-of-order message sequence from expected traffic, where the UE typically responds to the authentication request with the corresponding response payload.

Another class of attacks may demonstrate multivariate anomalies. For example, a Denial-of-Service (DoS) attack targeting the RAN from a malicious UE may be used. The UE establishes multiple fabricated RRC connections upon the authentication stage, which consumes the resources of the RAN and prevents other legitimate UEs from connecting. This attack differs from benign traffic in that the network observes malicious patterns with both abnormal message sequences and device parameters. In this instance, the RAN may be flooded with a rapid succession of uncompleted UE connection requests from a stream of temporary identifiers (RNTI), and thus these variables jointly constitute the attack pattern deviated from expected traffic.

### Example 6G-XSec Framework

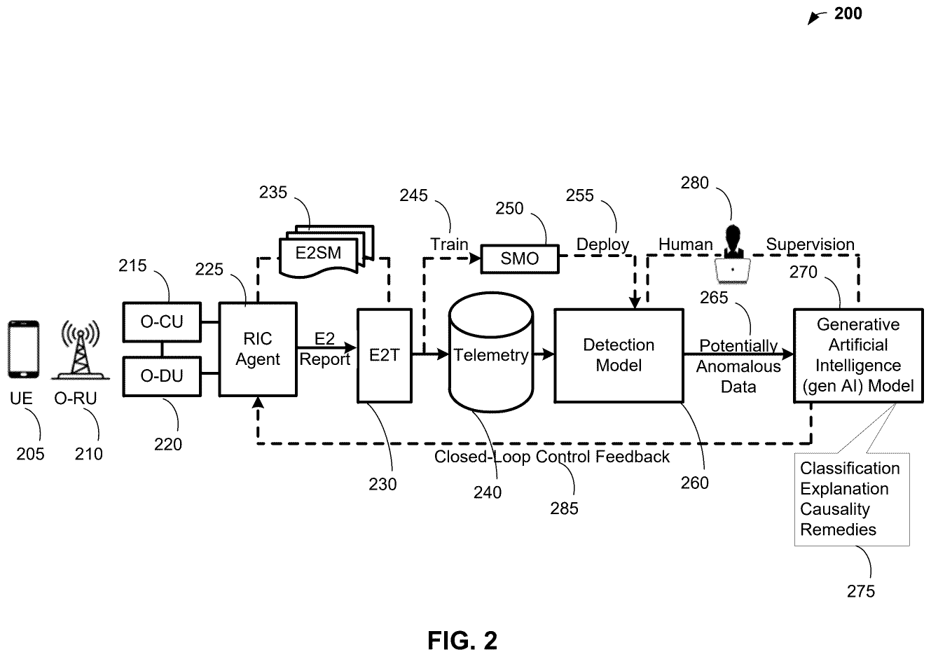

FIG. 2 illustrates an overview of an explainable edge security framework, in accordance with example embodiments. The process begins at the network edge, where User Equipment (UE) 205 connects to the cellular network via the Open Radio Unit (O-RU) 210. The protocol stack may be managed by the Open Distributed Unit (O-DU) 220 and the Open Central Unit (O-CU) 215. A specialized component known as the RIC Agent 225 may be embedded within these RAN elements to extract security-aware telemetry. This extraction can be standardized using E2 Service Models (E2SM) 235, and the telemetry may be transmitted via E2 Report messages to the E2 Termination (E2T) 230 interface, which serves as the entry point to the network controller.

Some embodiments involve receiving, by a network controller, telemetry data generated by a radio access network (RAN) data plane of a network device during runtime, wherein the telemetry data is indicative of communications between a base station and the network device. For example, the system initiates the security analysis pipeline by receiving telemetry data at a network controller during the runtime operation of the wireless network. As illustrated in FIG. 2, the network controller, depicted here as the Near Real-Time RAN Intelligent Controller (Near-RT RIC) or a component thereof, interfaces with the Radio Access Network (RAN) data plane to ingest real-time data streams. The receiving mechanism typically involves an E2 Termination (E2T) component 230, which acts as the ingress gateway for the network controller. This interface is configured to accept E2 Report messages transmitted over E2 interfaces, ensuring that the control plane maintains continuous visibility into the data plane's operational state without disrupting the latency-sensitive traffic flow.

The telemetry data itself may be generated by the RAN data plane, specifically by a RAN Intelligent Controller (RIC) Agent 225 embedded within the disaggregated base station components, such as the Open Central Unit (O-CU) 215 and the Open Distributed Unit (O-DU) 220. This generation process can occur during runtime. For example, the data can be extracted dynamically as user traffic traverses the network stack. To facilitate this extraction, the RIC Agent 225 may utilize dedicated E2 Service Models (E2SM) 235, which define the data schemas and collection triggers that capture security-relevant features from the raw network traffic. The collected telemetry is then aggregated into a database or Shared Data Layer (SDL) 240, making it immediately available for subsequent analysis by the detection models.

In some embodiments, the telemetry data includes security-aware telemetry data. As described herein, the received telemetry data is indicative of communications occurring between a base station and a network device (e.g., User Equipment or UE 205). In addition to reporting aggregate performance statistics (like throughput or latency), this security-aware telemetry captures the specifics of the control-plane signaling protocols. For instance, the data may include details regarding Radio Resource Control (RRC) messages and Non-Access Stratum (NAS) messages exchanged during connection setup, authentication, and mobility management procedures. By monitoring these specific communications, the system can inspect the precise sequence of interactions between the network device 205 and the RAN infrastructure (O-RU 210, O-DU 220, 0-CU 215), enabling the detection of anomalies such as out-of-order handshakes, identifier exhaustion attacks, or unauthorized parameter modifications.

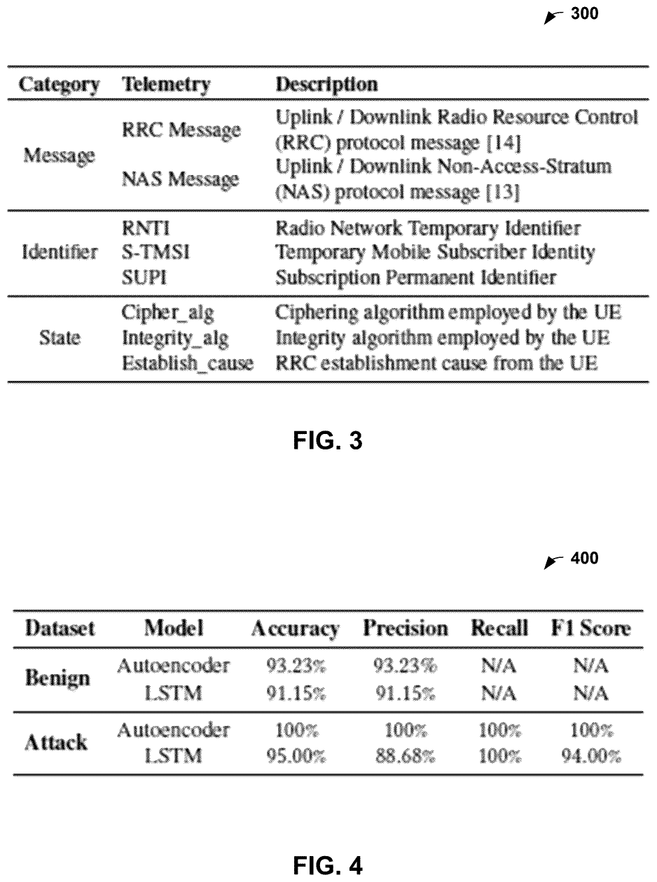

In some embodiments, the security-aware telemetry may be collected by configuring the cellular data plane with protocol-aware telemetry design. For example, the collection of security-aware telemetry may be achieved by configuring the cellular data plane, comprising elements such as the O-CU 215 and O-DU 220, with a protocol-aware telemetry design. As illustrated in FIG. 2, this configuration may be operationalized through the RIC Agent 225, which utilizes standardized E2SM 235 to define specific data extraction policies. Unlike traditional network monitoring that relies on aggregate performance counters, this protocol-aware design instructs the data plane to inspect and report granular attributes of the control signaling protocols, as detailed in FIG. 3. Specifically, the design captures categorizations of Message content (e.g., RRC and NAS protocol messages), specific Identifiers (e.g., RNTI, S-TMSI, SUPI), and State parameters (e.g., ciphering and integrity algorithms). This targeted configuration ensures that the telemetry stream contains the semantic richness that can distinguish benign connection attempts from sophisticated protocol-level attacks, such as identity extraction or null-ciphering exploits.

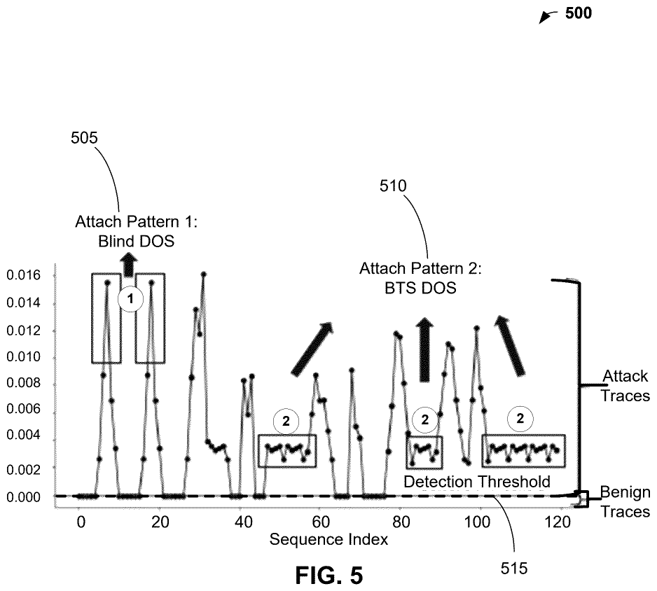

In some embodiments, the security-aware telemetry includes multivariate time-series data comprising a Radio Resource Control (RRC) message, or a Non-Access-Stratum (NAS) message, or both. For example, the security-aware telemetry may be structured as multivariate time-series data, capturing the sequential evolution of the network state in addition to isolated, static events. As detailed in FIG. 3, this data stream can encompass the control-plane signaling protocols exchanged between the User Equipment (UE) and the network infrastructure. For example, the telemetry comprises Radio Resource Control (RRC) messages, which govern connection establishment and radio bearer management between the UE and the Radio Access Network, and Non-Access-Stratum (NAS) messages, which handle core network functions such as authentication and mobility management. By treating these message flows as time-series data, often indexed sequentially as shown in FIG. 5, the system monitors the temporal order and inter-arrival times of the signals, allowing it to detect complex anomalies where the content of an individual message may be valid, but its context or frequency within the sequence violates the expected protocol state machine.

In some embodiments, the telemetry data includes one or more user equipment (UE)-specific parameters. In some embodiments, the one or more UE-specific parameters includes Radio Network Temporary Identifier (RNTI), Temporary Mobile Subscriber Identity (S-TMSI), Subscription Permanent Identifier (SUPI), a ciphering algorithm, an integrity algorithm, or a RRC establishment cause. For example, the collected telemetry data may be enriched with one or more User Equipment (UE)-specific parameters, allowing the system to track and analyze the behavior of individual devices within the network. As detailed in the “Identifier” and “State” categories of FIG. 3, these parameters encompass significant addressing fields, including the Radio Network Temporary Identifier (RNTI) for local cell identification, the Temporary Mobile Subscriber Identity (S-TMSI) for privacy-preserving tracking, and the Subscription Permanent Identifier (SUPI) which serves as the unique global ID for the subscriber. Furthermore, the UE-specific parameters capture security and operational context, recording the applied ciphering algorithm (Cipher_alg) and integrity algorithm (Integrity_alg) to verify the strength of the encryption and data protection in use, as well as the RRC establishment cause (Establish_cause) to document the specific reason provided by the UE for initiating the connection.

In some embodiments, the telemetry data may be reported by the network controller by using an extended E2 Service Model (E2SM) based on an E2SM-Key Performance Monitoring (E2SM-KPM) reference implementation. For example, the telemetry data may be reported to the network controller by leveraging an extended E2 Service Model (E2SM) that derives from the E2SM-Key Performance Monitoring (E2SM-KPM) reference implementation. As indicated in FIG. 2, the RIC Agent 225 employs these E2SM definitions 235 to format the security-relevant data before transmission. While E2SM-KPM definitions are generally limited to statistical performance counters, this extended model is adapted to encapsulate the granular, protocol-aware parameters, such as specific RRC message types and UE identifiers, that are significant for the security analysis. This standardization ensures that the raw telemetry generated by the RAN data plane is structured into compliant E2 Report messages, which are then transmitted via the E2 interface to the E2T 230 component of the network controller.

Once collected, the telemetry may be aggregated into a data storage layer 240, often referred to as the Shared Data Layer (SDL). This data serves two purposes: it feeds the runtime analytics and supports model evolution. For the latter, a training loop 245 transmits historical data to the Service Management and Orchestration (SMO) 250 layer, where models are trained or updated before being deployed 255 back to the runtime environment.

Some embodiments involve detecting, by a detection model, at least one potentially anomalous traffic sequence. For example, in the runtime path, a lightweight Detection Model 260 can monitor the telemetry stream. When this model identifies a traffic sequence that deviates from the established benign baseline, it flags the sequence as potentially anomalous data. In some embodiments, the potentially anomalous traffic sequence includes one or more of an attack on the base station, a fault in the RAN, a failure of the RAN, a security threat, a noncompliance by one or more network devices, or a violation of a service level agreement (SLA).

For example, the detected potentially anomalous traffic sequence can serve as a specific indicator of malicious interference or targeted hostility against the network infrastructure. For example, the sequence may represent an attack on the base station (e.g., the O-CU or O-DU) or a broader security threat. In such scenarios, the anomalous sequence typically manifests as a concerted effort to disrupt the Radio Access Network (RAN) availability or integrity. For example, a signaling storm attack might generate a sequence of high-frequency Radio Resource Control (RRC) connection requests designed to exhaust the computational resources of the base station, effectively causing a Denial of Service (DoS). Similarly, the sequence might reveal an Identity Extraction threat, where a rogue entity repeatedly initiates handshake procedures solely to harvest sensitive subscriber identifiers (such as SUPIs or IMSIs) before abandoning the connection.

In some embodiments, the potentially anomalous traffic sequence may be indicative of non-malicious operational deviations, such as a fault in the RAN, a failure of the RAN, or noncompliance by one or more network devices. In these embodiments, the detection model may identify sequences that deviate from the norm due to software bugs, hardware degradation, or protocol misconfigurations rather than active attacks. For instance, a fault or failure may be characterized by a sudden cessation of telemetry reports or an erratic sequence of retransmission requests caused by a malfunctioning radio unit. Furthermore, the system may detect a device noncompliance, where a specific User Equipment (UE), such as a poorly configured IoT sensor, transmits data at rates or intervals that violate the standardized 3GPP protocols or the specific Quality of Service (QoS) parameters defined for its slice, thereby triggering the anomaly detection threshold despite the absence of malicious intent.

Also, for example, the system may detect a violation of a service level agreement (SLA). For example, the detected anomaly may be indicative of a violation of a SLA, which constitutes a formal definition of the performance standards and quality of service (QoS) metrics guaranteed by the network operator to a subscriber or network slice tenant. Within this context, an SLA violation may be characterized by a deviation in the telemetry data that reflects a failure to meet specific Key Performance Indicators (KPIs) stipulated in the agreement, such as reduced throughput thresholds, increased latency limits (e.g., for Ultra-Reliable Low Latency Communications), packet loss rates, and/or network availability percentages. The detection model identifies such violations when the monitored traffic sequence exhibits performance characteristics that statistically drift below these agreed-upon operational baselines, thereby flagging the event as an anomaly even in the absence of malicious intent or security threats.

In some embodiments, the at least one potentially anomalous traffic sequence includes a network traffic sequence deviating from a baseline of network traffic patterns. For example, one criterion for identifying a potentially anomalous traffic sequence may be a statistical deviation of a traffic sequence from a learned norm, rather than a match against a predefined signature of known attacks. As described in the unsupervised anomaly detection framework, the system may establish a baseline of network traffic patterns by training on benign cellular traffic data, that is, data collected during network operations that do not have active threats. This baseline captures the latent representations and probability distributions of legitimate protocol behaviors, such as the typical order of Radio Resource Control (RRC) messages or the expected frequency of device registration requests.

The network traffic sequence deviating from this baseline may be identified when the runtime telemetry exhibits characteristics that fall outside these learned distributions. For example, in an Autoencoder-based implementation, the model compresses input sequences and attempts to reconstruct them. A sequence that cannot be accurately reconstructed, resulting in a high reconstruction error (e.g., Mean Squared Error) that exceeds a predefined threshold, may be flagged as a deviation. Similarly, in a sequence modeling approach using LSTMs, the model may predict the next expected telemetry value. In the event the actual received value differs significantly from this prediction, the sequence may be identified to constitute a deviation. This deviation-based approach allows the system to detect unknown unknowns or zero-day attacks (like novel signaling storms or identity extraction methods) that do not yet have known signatures but fundamentally disrupt the patterns of network traffic.

In some embodiments, detection model 260 integrated into the system may be designed as an unsupervised deep learning model. This architectural choice addresses a significant challenge in cellular network security: the scarcity of well-labeled datasets that include diverse adversarial attack samples. In some embodiments, the system may be trained using techniques other than supervised learning, which may require examples of both normal and malicious traffic to train a classifier. For example, the unsupervised model can be trained on benign cellular traffic data. By ingesting large volumes of operational data, the deep learning model learns the latent representations and distributions of legitimate network behavior. Consequently, the model is capable of identifying anomalies based solely on their deviation from this learned baseline, enabling the system to detect novel or “zero-day” threats that were not present in the training set.

The unsupervised deep learning model may be implemented using various neural network architectures capable of processing multivariate time-series data. In some embodiments, the model comprises an Autoencoder. This architecture functions by compressing the input sequence into a lower-dimensional latent representation and then attempting to reconstruct the original input from that compressed state. During inference, the model calculates a reconstruction error (e.g., Mean Squared Error) between the actual input and the reconstructed output. A high reconstruction error indicates that the input sequence does not conform to the learned patterns of benign traffic, thereby flagging it as an outlier or potential threat.

Alternatively, or in combination, the unsupervised deep learning model may comprise a sequence modeling architecture, such as a Long Short-Term Memory (LSTM) network. Given the sequential nature of cellular protocol message flows, an LSTM is well-suited to learn the temporal dependencies between consecutive telemetry data points. In this configuration, the model is trained to predict the next expected telemetry value based on a window of historical data. During runtime, if the actual received telemetry significantly deviates from the model's predicted output, the system can register this discrepancy as an anomaly. Both architectures allow the detection model to operate and automatically, filter raw network traffic to identify suspicious activities before passing them to a generative AI component for detailed explanation.

In some embodiments, the detection model may be architecturally integrated into the network controller as a modular software application, commonly referred to within the Open Radio Access Network (O-RAN) standards as an “xApp.” As depicted in FIG. 1, this xApp 160 may be hosted within the Near-RT RIC 135. By encapsulating the unsupervised deep learning logic, such as the Autoencoder or LSTM models, within an xApp container, the system leverages the “plug-and-play” capabilities of the software-defined network architecture. This modular design allows the security detection function to be deployed, updated, and/or scaled independently of the underlying RAN infrastructure or other network management applications.

The integration of the detection model into an xApp facilitates direct and efficient access to the runtime security telemetry. The xApp interacts with the underlying platform services and the E2T interface to subscribe to data streams generated by the RIC Agents in the RAN data plane (e.g., RAN data plane 110). In some embodiments, the xApp defines its data requirements using E2 Service Models (E2SMs), such as the extended E2SM-KPM, enabling it to ingest the granular MobiFlow telemetry required for anomaly detection. Once the data is reported via the E2 interface, the xApp can retrieve the aggregated time-series data from the Shared Data Layer (SDL), a centralized database accessible to authorized control-plane services.

Furthermore, operating as an xApp allows the detection model to function alongside other network applications without disrupting significant operations. The O-RAN architecture provides that the xApp operates in a sandboxed environment, utilizing the RIC's APIs and Software Development Kits (SDKs) for resource management and message routing. This isolation ensures that the heavy computational load of the deep learning inference, calculating reconstruction errors or predicting telemetry sequences, does not interfere with the real-time scheduling or handover functions of the cellular network. Upon detecting an anomaly, the xApp can trigger downstream processes, such as the generative AI analysis or automated remediation policies, thereby closing the loop between detection and response at the network edge.

Some embodiments involve, responsive to the detecting of the at least one potentially anomalous traffic sequence, providing the at least one potentially anomalous traffic sequence to a generative artificial intelligence (gen AI) model different from the detection model. For example, detection of the at least one potentially anomalous traffic sequence triggers the engagement of a Generative Artificial Intelligence (gen AI) Model 270, which performs a high-level analysis of the flagged sequence. In some embodiments, the gen AI model includes a large language model (LLM). In some embodiments, the gen AI model includes a large language model (LLM) analyzer xApp.

For example, the gen AI model may be implemented as a LLM, such as any existing commercially available LLMs, capable of sophisticated natural language processing and reasoning. This LLM may be configured to ingest the potentially anomalous traffic sequences converted into text-based formats and apply its pre-trained knowledge of telecommunications standards (e.g., 3GPP specifications) to deduce the nature and cause of the anomaly. Furthermore, in some architectural implementations, this gen AI model may be deployed as a specialized LLM analyzer xApp. In this configuration, the LLM logic may be containerized as a modular software application hosted directly on the network controller (e.g., the Near-RT RIC). As an xApp, the analyzer can integrate seamlessly with the platform's service framework, subscribing to data feeds from the detection model and publishing security assessments back to the control plane, thereby embedding advanced generative reasoning directly into the edge network's runtime environment.

In some embodiments, the LLM Analyzer xApp may be configured to access the LLM through RESTful web APIs from a pre-trained LLM or a locally fine-tuned model. For example, the LLM Analyzer xApp may be architected to function as a gateway that decouples the network control logic from the underlying gen AI inference engine. The xApp may be configured to access the LLM by issuing HTTP requests via RESTful web APIs, ensuring compatibility with a wide range of model deployment strategies. This API-driven interface allows the xApp to query a commercially available, pre-trained LLM hosted in a public or private cloud (e.g., commercially available LLMs) for broad, zero-shot reasoning capabilities. Alternatively, the same RESTful interface can be configured to target a locally fine-tuned model hosted on-premises or at the network edge. This local configuration can be advantageous for scenarios requiring enhanced data privacy or specialized knowledge of proprietary network configurations, as it allows the system to leverage a smaller, domain-specific model (e.g., a fine-tuned LLM) without transmitting sensitive telemetry data to external third-party servers.

A cloud provider service can install and operate application software in the cloud and users can access the software service from the client devices. Cloud users who have a site in the cloud may not solely manage the cloud infrastructure and platform where the application runs. Thus, the servers and databases may be shared hardware where the user is given some amount of dedicated use of these resources. The user's cloud-based site may be given a virtual amount of dedicated space and bandwidth in the cloud. Cloud applications can be different from other applications in their scalability which can be achieved by cloning tasks onto multiple virtual machines at run-time to meet changing work demand. Load balancers distribute the work over the set of virtual machines. This process can be transparent to the cloud user, who may see a single access point. The cloud-based remote access may be coded to utilize a protocol, such as Hypertext Transfer Protocol (HTTP), to engage in a request and response cycle with both a mobile device application resident on a client device as well as a web-browser application resident on the client device.

In some embodiments, the gen AI model includes a large multimodal model (LMM). The LLM can extend the system's analytical capabilities beyond text-based processing to include visual data interpretation. Unlike Large Language Models (LLMs) that rely solely on textual descriptions of telemetry, an LMM may be configured to ingest and analyze graphical representations of the network data, such as the reconstruction error plots illustrated in FIG. 5. By processing these visual inputs, the LMM may directly identify distinct geometric shapes and trends associated with specific attack vectors, such as the sharp, isolated spikes characteristic of a Blind DoS attack or the broader, oscillating sawtooth patterns indicative of a BTS DoS attack. This multimodal approach allows the model to correlate visual anomalies with the underlying numerical telemetry, providing a more robust and holistic security assessment that leverages both the semantic understanding of protocol logs and the pattern recognition of signal visualizations.

In some embodiments, the system can employ a cascaded architecture where the generative AI model is engaged conditionally, rather than monitoring the data stream at all times. By being responsive to the detecting of an anomaly by the initial detection model, resource efficiency may be achieved in 5G/6G edge environments. Because generative AI models (such as Large Language Models or LLMs) are computationally intensive and may introduce significant latency and/or cost if queried for every network event, they may be reserved for high-value analysis. The lightweight detection model (e.g., the Autoencoder or LSTM) acts as a pre-filter, scanning the high-volume telemetry stream to identify deviations. In the event the primary layer flags a traffic sequence as potentially anomalous does the system trigger the secondary analysis layer, thereby decoupling the detection task from the more resource-heavy explanation task.

Upon triggering, the providing step may involve more than merely forwarding an error code. For example, it can involve constructing a comprehensive data payload for the generative AI. The system may aggregate the potentially anomalous traffic sequence along with a surrounding context window, capturing data points both immediately preceding and following the anomaly, to provide the gen AI with temporal context. Some embodiments may involve formatting the raw telemetry (e.g., RNTI values, message types, timestamp deltas) into a structured prompt. This prompt may be augmented with a system persona (instructing the model to act as a security analyst) and data schema descriptions, enabling the generative model to interpret the cryptic numerical and categorical values of the cellular protocols without requiring prior fine-tuning on that specific dataset. This stage may optionally involve Human Supervision 280, allowing an operator to oversee the analysis or query the system 265.

In some embodiments, the providing of the at least one potentially anomalous traffic sequence to the gen AI model may involve providing the at least one potentially anomalous traffic sequence in batch mode, wherein a batch comprises a plurality of detected potentially anomalous traffic sequences. For example, the system may be configured to optimize the interaction between the network controller and the generative AI model by operating in a batch mode. The system may be configured to not initiate a separate API call or query for a single anomaly upon detection, which could potentially introduce significant network overhead and rapidly deplete rate limits for external AI services. In some embodiments, the system may be configured to aggregate detected threats over a defined time window or until a specific volume threshold is reached. In this configuration, the providing step entails accumulating a plurality of detected potentially anomalous traffic sequences into a single, consolidated payload or a queue structure before transmission to the generative AI model.

Such a batch processing approach can be particularly advantageous for post-mortem analysis and non-real-time auditing scenarios. For instance, the detection model (e.g., the unsupervised autoencoder) may run on the live telemetry stream, flagging anomalies as they occur and storing them in a local buffer or the Shared Data Layer (SDL). Subsequently, at a scheduled interval (e.g., hourly or nightly), an orchestration component retrieves this collection of flagged sequences and submits them as a batch job to the generative AI. This allows the generative AI to process the group of anomalies efficiently, potentially identifying broader patterns or correlations across the plurality of sequences that might be missed if each were analyzed in isolation. The system then receives a corresponding batch of security assessments, which can be reviewed by network operators during routine maintenance cycles rather than demanding immediate attention for every minor deviation.

In some embodiments, the providing of the at least one potentially anomalous traffic sequence to the gen AI model may involve receiving a user indication to provide the at least one potentially anomalous traffic sequence to the gen AI model. Such embodiments involve providing the at least one potentially anomalous traffic sequence in response to the user indication. For example, the workflow for engaging the gen AI model may be initiated by a direct human command. Such an on-demand configuration can serve as an analyst-assist tool, allowing network operators to selectively investigate specific incidents. In this operational mode, the system first detects and logs potential anomalies using the unsupervised detection model, perhaps displaying them on a security dashboard or alert log. The computationally expensive and potentially costly step of querying the generative AI model can be paused until the system receives a user indication.

This user indication can effectively act as a manual gate or authorization signal. For example, a security analyst reviewing a list of flagged events may identify a particularly ambiguous or high-severity alert and click a “Analyze with AI” button or issue a specific query via a chat interface. In response to this explicit user indication, the system can retrieve the relevant traffic sequence and context window, format it into a prompt structure, and transmit it to the gen AI model. This approach ensures that the advanced reasoning capabilities of the gen AI are focused solely on the events that human operators deem worthy of deeper investigation, thereby optimizing resource usage and keeping the human in the loop for significant decision-making.

In some embodiments, the providing of the at least one potentially anomalous traffic sequence to the gen AI model may involve providing input to the gen AI model using a zero-shot prompt template. This approach leverages the pre-trained capabilities of Large Language Models (LLMs) to analyze network telemetry and not have to rely on the model to be fine-tuned on specific security datasets or provided with prior examples of attack versus benign classifications within the prompt itself. By relying on the model's knowledge of telecommunications standards (such as 3GPP specifications) and general cybersecurity principles, the system reduces the computational overhead and token usage associated with more complex prompting strategies like few-shot learning.

Some embodiments involve receiving, from the gen AI model, a security assessment characterizing the at least one potentially anomalous traffic sequence, wherein the security assessment comprises a language explanation of a cause of the at least one potentially anomalous traffic sequence. For example, the Gen AI Model 270 may output a comprehensive security assessment 275, which includes the classification of the threat, a language explanation of the cause, a determination of causality, and/or suggested remedies.

The zero-shot prompt template may be a structured instruction set that frames the analysis task for the AI. The template typically begins by establishing a persona, instructing the model: “You are an AI security analyst tasked with identifying potential attacks within a 5G network.” Following this, the template includes placeholders for <DATA_DESCRIPTIONS> and <DATA>, where the system dynamically inserts the definitions of the telemetry attributes (e.g., explaining RNTI or RRC message types) and the specific sequence of values flagged by the detection model. The prompt concludes with a direct command to “Determine whether this sequence is anomalous or benign and explain why,” and to list the “top 3 most possible attacks” if a threat is detected. This format allows the system to obtain immediate, actionable intelligence directly from the raw anomaly data in a single inference step.

In some embodiments, the prompt template may include: (i) a system prompt defining a security analyst persona, (ii) a data schema description defining the format of the telemetry data, and (iii) the at least one potentially anomalous traffic sequence converted into a text-based format. For example, the prompt template utilized to query the gen AI model may be constructed with three distinct components designed to contextualize the raw anomaly data for effective semantic analysis. First, the template includes a system prompt that explicitly defines a professional persona, instructing the model to operate as “an AI security analyst tasked with identifying potential attacks within a 5G network.” Second, the template may incorporate a data schema description (shown as <DATA_DESCRIPTIONS>) which defines the format and meaning of the telemetry data attributes. This provides the gen AI model with the semantic dictionary to understand that specific numerical values correspond to distinct network concepts like “RNTI” or “RRC Setup” messages. Third, the template may embed the at least one potentially anomalous traffic sequence itself (shown as <DATA>), which is converted from the raw numerical or binary output of the detection model into a structured text-based format, such as a serialized list or JSON object, allowing the text-processing gen AI to parse and reason about the specific sequence of network events.

In some embodiments, the system may receive a detailed security assessment from the generative AI model, representing a transformation of raw numerical anomalies into actionable intelligence. As depicted in FIG. 2, the Gen AI Model 270 generates a comprehensive security assessment 275 that characterizes the potentially anomalous traffic sequence. Unlike traditional intrusion detection systems that might output a cryptic error code or a simple binary alert (e.g., “Malicious: Yes/No”), the generative AI provides a “language explanation” of the cause. This explanation synthesizes the contextual data provided in the prompt, such as the specific sequence of Radio Resource Control (RRC) messages or the behavior of temporary identifiers, to construct a coherent narrative describing why the observed behavior deviates from the norm. For instance, instead of merely flagging a spike in connection requests, the Gen AI Model 270 may explain that “repeated connection setup requests with unchanging Temporary Mobile Subscriber Identity (TMSI) values indicate a signaling storm intended to overwhelm the base station.”

In some embodiments, the security assessment includes one or more of: (i) classification of an anomaly, (ii) explainability of why the at least one potentially anomalous traffic sequence is anomalous, (iii) causality defining a responsible party, or (iv) remediation steps to mitigate the threat. For example, the security assessment generated by the system serves as a multi-dimensional diagnostic report that is more complex than a simple alert. As illustrated by the output 275 in FIG. 2, this assessment comprises one or more analytical components. First, it provides a classification of the anomaly, mapping the observed deviation to known threat categories such as a Denial of Service (DoS), Man-in-the-Middle (MitM) attack, or an Identity Extraction attempt. Second, it ensures explainability, providing a natural language narrative that clarifies why the specific traffic sequence is anomalous, for example, by pointing out that a rapid succession of RRC Setup Requests without corresponding Complete messages violates protocol logic. Third, the assessment establishes causality, identifying the responsible party or the root cause of the issue, whether it be a malfunctioning User Equipment (UE), a rogue base station, or an external attacker. Finally, the assessment includes actionable remediation steps, recommending specific control-plane interventions, such as blocking a malicious Radio Network Temporary Identifier (RNTI) or initiating a handover, to immediately mitigate the threat.

Some embodiments involve providing the security assessment. In some embodiments, the providing of the security assessment includes providing the security assessment to a closed-loop control feedback mechanism. For example, to complete the automated defense cycle, a Closed-Loop Control Feedback Mechanism 285 transmits remediation policies or control commands back to the RIC Agent 225 to mitigate the threat in real-time. For example, the process involves providing the security assessment to a consumption endpoint configured to act upon the generated intelligence. The providing of the security assessment may include transmitting the assessment data, such as the threat classification and recommended remedies, to a closed-loop control feedback mechanism. As illustrated in FIG. 2, this mechanism 285 serves as the bridge between the analytical plane and the control plane, transforming the system from a passive monitoring solution into an active defense architecture. By routing the insights directly to an automated controller (in addition to or instead of) to a human dashboard, the system enables self-healing capabilities, allowing the network to respond to security incidents at machine speed and reducing the latency in manual operator review.

In some embodiments, the closed-loop control feedback mechanism may automatically perform one or more of security countermeasure deployment or fault recovery through data plane control primitives. For example, to complete this automated defense cycle, the Closed-Loop Control Feedback Mechanism 285 may process the received assessment to derive executable instructions. It may subsequently transmit specific remediation policies or control commands back to the RIC Agent 225 embedded within the RAN data plane. For example, if the generative AI model identifies a specific device as the source of a signaling storm, the feedback mechanism can instantly issue a directive to the RIC Agent to block the Radio Network Temporary Identifier (RNTI) associated with that device. This transmission and execution can occur in real-time, effectively mitigating the threat at the network edge before it can propagate to the core network or degrade the quality of service for legitimate users.

In some embodiments, the providing of the security assessment includes providing the security assessment (1) to a closed-loop control feedback mechanism, (2) for human supervision, or (3) both. For example, the providing of the security assessment may involve transmitting the generated insights to one or more consumption endpoints, which may be either human-operated interfaces or automated network control systems. As illustrated in FIG. 2, the output of the Generative AI Model 270 may be routed to effective downstream components to realize the explainable and actionable goals of the framework.

In some embodiments, the human supervision is enabled to compare an output of the gen AI model with an output of the detection model to identify a contradiction. For example, the system may be configured to facilitate human supervision by enabling an operator to compare an output of the generative AI model with an output of the detection model to identify a contradiction. For example, a security analyst interface may simultaneously display the visualization of the anomalous traffic sequence generated by the detection model, such as a time-series plot of reconstruction errors showing a specific spike, alongside the textual security assessment provided by the generative AI model. This side-by-side presentation empowers the human expert to verify whether the narrative explanation (e.g., a claim that the anomaly represents a Signaling Storm) aligns with the empirical evidence of the raw telemetry data. If the gen AI model produces a hallucinated explanation that is unsupported by the visual or numerical data, such as attributing a high-frequency spike to a low-frequency event, the operator can identify this contradiction and intervene, thereby rejecting the assessment and preventing the execution of erroneous automated remediation policies.

In some embodiments, the providing of the security assessment may involve displaying the natural language explanation and threat classification on a graphical user interface (UI) accessible to a network security analyst. Such embodiments may support a “human-in-the-loop” workflow. Here, the system may present a visualization of the anomalous traffic sequence (as shown in FIG. 5) alongside the AI-generated narrative. This allows the operator to review the AI's reasoning, verify the “top 3 most possible attacks,” and manually authorize recommended remediation steps. This manual supervision step can be particularly valuable for mitigating the risk of AI hallucination, allowing human experts to cross-reference the AI's assessment against the raw telemetry data before taking disruptive network actions.

Some embodiments involve displaying a visualization of the potentially anomalous traffic sequence on a user interface. Such embodiments involve receiving a user query associated with the visualized sequence. Such embodiments also involve providing a context window to the gen AI model in response to the user query. For example, the system facilitates interactive analysis by displaying a visualization of the potentially anomalous traffic sequence on a user interface. As illustrated in FIG. 5, this graphical representation, such as a time-series plot of reconstruction errors, allows an operator to visually pinpoint deviations in the network traffic. Such embodiments involve receiving a user query associated with the visualized sequence, where an analyst may highlight a specific segment or input a natural language question like “What triggered this spike?” regarding the observed pattern. In response to this user query, the system provides a context window to the generative AI model. This process involves packaging the specific subset of telemetry data corresponding to the visualized timeframe alongside the user's text, thereby grounding the AI's analysis in the precise numerical context of the event being inspected.

Some embodiments involve determining a consensus between the detection model and the gen AI model. Such embodiments involve facilitating a security response action when both the detection model and the gen AI model classify the at least one traffic sequence as anomalous. For example, the system enhances decision reliability by determining a consensus between the detection model and the generative AI model before initiating active countermeasures. In this configuration, a security response action is facilitated when both the detection model, operating on numerical outlier probabilities, and the generative AI model, operating on semantic reasoning, independently classify the at least one potentially anomalous traffic sequence as anomalous. For instance, the system may be configured so that the detection model's reconstruction error exceed a predetermined threshold and that the generative AI model categorize the sequence as a recognized threat type (e.g., “DoS Attack”) instead of “Benign Noise.” Such a dual-validation acts as a safeguard against false positives, ensuring that automated mitigation steps, such as blocking a user or resetting a cell, are executed when the statistical evidence and the semantic interpretation mutually reinforce the diagnosis of a security breach.

In some embodiments, the providing of the security assessment may involve transmitting the assessment data to a closed-loop control feedback mechanism 285. In this automated configuration, the assessment, such as the recommended remediation action, may be parsed and routed back to the RAN Intelligent Controller (RIC) or the Service Management and Orchestration (SMO) layer. This enables the network to perform self-healing operations. For example, if the assessment identifies a Denial of Service attack originating from a specific device identifier (RNTI), the feedback loop can automatically trigger a control primitive at the RIC Agent 225 to disconnect that user or update a firewall policy to block the malicious signaling pattern, thereby achieving rapid fault recovery at machine speed.

In some embodiments, the providing of the at least one potentially anomalous traffic sequence to the gen AI model, the receiving of the security assessment, or both, may be performed by an autonomous agent configured to orchestrate data flow between the network controller and the gen AI model. For example, the system architecture may incorporate an autonomous agent designed to orchestrate the complex data flow between the real-time network controller and the generative AI model. Rather than establishing a direct, synchronous coupling between the high-speed Radio Access Network (RAN) infrastructure and the computationally intensive Large Language Model (LLM), this autonomous agent can act as an intelligent intermediary. This agentic architecture decouples the two domains, allowing the network controller (e.g., the Near-RT RIC) to focus on sub-millisecond control loops while the agent manages the asynchronous, high-latency interactions for deep semantic analysis.

In some embodiments, the autonomous agent can be configured to manage the providing step by implementing intelligent routing logic. For example, instead of flooding the generative AI model with every minor deviation detected by the unsupervised model, the agent may batch multiple potentially anomalous sequences together or prioritize them based on severity before initiating an API call to the model. This orchestration ensures that the generative AI resources are utilized efficiently and cost-effectively. Furthermore, the agent may handle the data transformation, converting the raw numerical telemetry and context windows into the specific prompt structures (including system personas and data schema descriptions) that enable the generative AI to function accurately.

In some embodiments, the autonomous agent can handle the receiving of the security assessment, acting as a post-processing logic layer. Upon receiving the natural language explanation or remediation advice from the generative AI, the agent can interpret the output and route it to the appropriate destination. In some embodiments, the autonomous agent may format the assessment for display on a security operations dashboard, waiting for human verification. In a fully automated mode, the agent may parse the text to extract specific directives (e.g., “block RNTI 0x5F”) and forward these structured commands to the network controller's closed-loop feedback mechanism, thereby completing the security response cycle and not having to rely on human intervention.

To enable such operations as described in FIG. 2, the RAN data plane may be extended to collect security telemetry and report through the O-RAN E2 interface to the nRT-RIC. Next, the telemetry may be analyzed by an unsupervised anomaly detector xApp (MOBIWATCH) to identify deviated traffic patterns. Subsequently, the anomalous traces may be processed by an LLM-based expert referencing to generate insights for threat explanation. The following describes these components.

### Security Telemetry Collection

### Telemetry Definition

Data telemetry is the foundation for any data-driven AI techniques. Existing service models in the O-RAN standards provide coarse-grained security telemetry that mainly focuses on network performance monitoring, which is thus inadequate to monitor and detect sophisticated cellular threat at the edge. To address this limitation, the design of MOBIFLOW security telemetry may be adapted, which extends the cellular data plane to collect fine-grained states and statistics at the cellular protocol level. An example list of MOBIFLOW telemetry is described in table 300 of FIG. 3.

FIG. 3 illustrates a table 300 with example telemetry data, in accordance with example embodiments. The security-aware telemetry data collected by the system is illustrated as organized into three columns: Category, Telemetry, and Description. Table 300 delineates three primary categories of data used for anomaly detection: Message, Identifier, and State.

The Message category tracks the actual protocol packets exchanged between the device and the network. It captures RRC Messages, referring to both Uplink and Downlink Radio Resource Control protocol messages used for connection management, and NAS Messages, referring to Uplink and Downlink Non-Access-Stratum protocol messages used for core network signaling.

The Identifier category lists specific identifiers used to track User Equipment (UE) within the radio network. It includes the Radio Network Temporary Identifier (RNTI), the Temporary Mobile Subscriber Identity (S-TMSI), and the Subscription Permanent Identifier (SUPI), which serves as the unique, permanent ID for a mobile subscriber.

The State category captures the security status and operational context of a connection. It includes Cipher_alg (the ciphering or encryption algorithm employed by the UE), Integrity_alg (the data integrity algorithm employed by the UE), and Establish_cause, which is the reason code provided by the UE when it requests to establish an RRC connection.

The collected telemetry may be formulated as multivariate time-series data entries, where a telemetry entry xᵢ is collected at a control message transmission:

$${x}_{i}^{T} = [ {t}_{i} , {m}_{i} , {p}_{1 i} , {p}_{2 i} , {p}_{3 i} , … , {p}_{ki} ] \qquad ( Eqn . 1 )$$

where mᵢ represents the message, and pₖᵢ denotes the UE-specific parameter from a defined parameter set pₖᵢ∈K collected at timestamp tᵢ. Therefore, a time series collected from the RAN spanning M messages is denoted by:

$$𝒯 = \{ {x}_{1} , {x}_{2} , {x}_{3} , … , {x}_{M} \} \qquad ( Eqn . 2 )$$

The message mᵢ may be collected from RRC and NAS protocol packets. The parameter set may include UE-specific identifiers and state parameters. The listed telemetry can be extracted from RAN interfaces, such as F1 Application Protocol (F1AP) and NG Application Protocol (NGAP). By instrumenting these interfaces or parsing the pcap streams, the RIC agent at the RAN data plane can extract, encode, and report the telemetry to the nRT-RIC. In some embodiments, the telemetry report may be based on an established subscription between an xApp and the RAN, and the telemetry may be decoded and handled by a custom xApp logic. To comply with the E2SM standard, the E2SM-KPM service model may be extended from the O-RAN reference implementation. This service model enables the RIC agent to report security telemetry via the E2 report operation per time interval, where the telemetry can be encoded as (key, value) data. Upon receiving the security telemetry, the xApp can store it in the Shared Data Layer (SDL) which is a centralized database that can be accessed by other nRT-RIC services and xApps.

### Unsupervised Anomaly Detection

Machine learning techniques for detecting security threats may be broadly classified into either supervised or unsupervised approaches. Particularly in the cellular domain, one challenge for training a supervised classifier lies in the scarcity of well-labeled datasets in the wild. While there are a few public datasets available, they are collected from LTE networks or do not involve control-layer traffic. Another challenge is obtaining adversarial data samples (e.g., attack traces). Due to these reasons, an unsupervised approach may be adopted, which has been widely used in security intrusion or anomaly detection. From the attack descriptions previously described, cellular attacks typically exhibit some levels of group anomalies (e.g., out-of-order message sequences), and these outliers may be distinguishable from benign traffic. Therefore, an unsupervised neural network may be trained on available benign cellular traffic data, through which the model can learn the latent representations and is capable of estimating how to distinguish unknown data deviations from the benign data distributions.

Such a problem setup is similar to existing multivariate outlier detection tasks. The unsupervised anomaly detection xApp consumes the multivariate time series g as the input. A sliding window of size N may be used to convert the time-series data into sequences S={S₁, . . . , S_{M-N+1}}, where a sequence Sᵢ={xᵢ, . . . , x_{i+N-1}}. Categorical variables within a sequence S may be one-hot encoded. The objective is to learn a mapping function φ:S [symbol] Z where Z∈ [symbol] ^{M-N+1}. Therefore, when given an unseen sequence Ŝₙ={\hat{x}ₙ, . . . , \hat{x}_{n+N-1}}, the model can output an anomaly score measuring the extent to which the given sample deviates from the trained data. Based on a predefined threshold, a final decision y∈{0, 1} may be produced where 1 indicates the given sequence is anomalous.

The unsupervised deep learning approaches to detect anomalous behaviors indicative of faults or security threats from the telemetry are described herein. Various unsupervised techniques for outlier detection may be used. These models may be trained with expected data (e.g., do not include attacks) and tested on unseen data that has a mixture of expected and abnormal flows.

Autoencoders are neural network architectures that compress an input vector to a lower dimensional representation and use that to create the original input vector, formulated as Ŝ=f_{AE}(S). In doing so, the autoencoders fit their internal parameters to reduce the reconstruction error between the input and the reconstructed output, thereby learning to represent the input data distribution. Any outlier sequences Ŝ when passed through the model may exhibit a large reconstruction error (e.g., mean square error), thus indicating an outlier.

Owing to the fact that security telemetry captures the cellular protocol message flows, they can be naturally represented as sequence data. In some embodiments, a Long Short Term Memory model (LSTM) model may be applied to this representation. The LSTM may be trained on expected flow sequences, to predict the next telemetry, denoted by \hat{x}_{i+N}=f_{LSTM}(xᵢ, . . . , x_{i+N-1}), depending on the window size N. In the event the actual telemetry x_{i+N} deviates from the model's predicted output \hat{x}_{i+N}, it may be identified as an outlier.

These unsupervised anomaly detection models may be integrated into an xApp, namely MOBIWATCH in the nRT-RIC, as illustrated in FIG. 2. Through the internal communication interfaces (e.g., the message routing mechanisms in the O-RAN reference implementation), the xApp can access the SDL for the dynamic security telemetry from the networks. Regarding the model training and deployment, it can be conducted either through an offline fashion or in the Service Management and Orchestration (SMO) infrastructure on the O-RAN control plane. Incoming telemetry for real-time inference may be performed with the deployed models in the xApp, which outputs the decision of whether a given input sequence is anomalous and may benefit from further analysis.

### Example ML-Based Expert Referencing

LLMs exhibit significantly advanced text summarization, comprehension, and deduction abilities, including network management and incidence analysis. In some embodiments, an LLM's deduction capabilities may be leveraged for explainable security, specifically to generate domain-specific insights including what the anomalies may be (classification), why the cellular sequence may be anomalous (explainability), who may be responsible (causality), and how to mitigate the threat (remediation).

FIG. 2 depicts the integration of a control-plane xApp for LLM-based expert referencing. Once MOBIWATCH flags a cellular sequence as anomalous, the sequence (and optionally a context window associated with the sequence) may be passed to the LLM xApp. The motivation for chaining a lightweight anomaly detector and the LLM analyzer is that LLMs are generally significantly large and expensive to deploy and invoke in a cellular network as it may introduce a high volume of cellular traffic in practice. The MOBIWATCH xApp serves as a pre-filter that extracts the meaningful and novel network incidents that may be further analyzed. Additionally, the results from MOBIWATCH and LLM may be cross-compared to ensure the decisions are reliable. Upon receiving the sequences, the xApp may construct inputs based on prompt templates and access the LLMs through RESTful web APIs from either a pretrained LLM (e.g., a commercially available LLM) or a locally fine-tuned model. Generally speaking, an LLM's prediction may not be accurate. As such, human supervision may be used in cases such as when the LLM and the anomaly detector generate contradictory results.

### Example Evaluations

A significant challenge in cellular security research is the scarcity of open traffic datasets, especially adversarial samples with anomalous or attack traces. As a proof-of-concept, a 5G network testbed may be built for experimentation and data collection as 6G standards are currently under development.

### Testbed Setup

In some embodiments, an end-to-end 5G standalone (SA) network may be built with open-sourced software and commodity hardware platforms. For example, an OpenAirInterface (OAI) may be used as a gNodeB (CU and DU) and core network implementations, and a commodity software-defined radio (SDR) Ettus USRP B210 may be used as the RU front-end. In some embodiments, the OAI CU may be extended with an E2 RIC agent that extracts security telemetry and handles communication with the nRT-RIC's E2 interface. The O-RAN Software community (OSC)'s nRT-RIC reference implementation may be adopted. This enables the architecture described in FIG. 2. The testbed setup may be deployed in a standalone Ubuntu 20.04 desktop with 12 Intel i7 CPU cores and 32 GB RAM.

### Dataset Collection

Based on the testbed, benign and attack datasets may be collected. To ensure the diversity of the benign cellular traffic, different data collection platforms and strategies may be used. For example, traffic from four different commodity 5G smartphone models (including Google Pixel 5 and 6, Samsung Galaxy A22, and A53) may be collected. Also, for example, COLOSSEUM, a software-defined large-scale 5G network emulator capable of generating traffic in various traffic scenarios, may be leveraged, and the test network may be deployed on top running open-sourced UEs from OAI. To collect data, the F1AP and NGAP interface may be instrumented to obtain pcap streams, which may be parsed and converted to security telemetry formats. In some embodiments, 2.5 MB of pcap files for benign traffic may be collected, constituting over 100 UE sessions with the network. This dataset may be further converted into inserting malicious logic into the OAI's UE stack, based on their descriptions from existing approaches. To ensure no real-world devices are affected, the attack dataset collection may be conducted on COLOSSEUM. This attack dataset may be converted into 126 lines of security telemetry.

### Dataset Labeling

Several approaches may be used to label the datasets. For example, traces from benign datasets may be naturally considered benign. Also, for example, attack datasets contain a mixture of benign and malicious sequences as an attack that occurs at a particular point within a network session. In some embodiments, malicious telemetry entry, xᵢ∈ [symbol] , may be manually identified and labeled, and sequences that involve xᵢ to be malicious, i.e., {S_{i-N+1}, . . . , Sᵢ}, for window size N.

In some embodiments, an evaluation may be performed to determine whether a lightweight unsupervised deep learning model can effectively detect deviated patterns that represent anomalies and threats in cellular networks. The benign dataset may be used to train the models, by leveraging categorical features in the security telemetry described in table 300 of FIG. 3 including the control messages and device identifiers such as UE's RNTI and TMSI. Both training procedures may be conducted with 500 epochs and a 10⁻³ learning rate. After training, a 99% percentile threshold among the reconstruction errors may be selected for anomaly detection, assuming 1% outliers within the training set caused by network noise.

FIG. 4 presents a table 400 summarizing the detection performance, in accordance with example embodiments. FIG. 4 summarizes the detection performance from both the Autoencoder and the LSTM models. The results indicate that both models deployed at MOBIWATCH correctly classified attack sequences as anomalous, indicating 100% recall or no false negatives. A small portion of false positives (<10%) may be observed in both the benign (through cross-validation) and the attack datasets. Through investigation of these samples, the primary causes appear to be unusual message sequences and network interference (e.g., RRC message retransmissions). Since the collected dataset is relatively small, the dataset and evaluation methodology may be expanded.

The detection performance in FIG. 4 is based on of two deep learning models, an Autoencoder and a Long Short-Term Memory (LSTM) network, when evaluated against both benign and attack datasets. The results are categorized by dataset type. For network traffic for the benign dataset, the Autoencoder achieved an accuracy and precision of 93.23%, slightly outperforming the LSTM model, which scored 91.15% in both metrics. The Recall and F1 Score metrics are listed as “N/A” for this category, reflecting that these metrics (which measure the correct identification of positive “attack” classes) are not applicable to a dataset containing benign traces.

When testing against attack scenarios, the models showed high effectiveness. The Autoencoder achieved a performance of 100% across various metrics: Accuracy, Precision, Recall, and F1 Score. The LSTM model also achieved 100% Recall (successfully flagging attack instances) and a high accuracy of 95.00%, though it demonstrated slightly lower precision (88.68%) and F1 Score (94.00%) compared to the Autoencoder. To further facilitate analysis of the results, the reconstruction errors of the attack sequences from the Autoencoder model may be visualized. FIG. 5.

FIG. 5 presents a visualization 500 of the reconstruction errors generated by the unsupervised Autoencoder model, in accordance with example embodiments. In FIG. 5, data points above the threshold bar are considered outliers, and those under the bar are considered benign. Similar patterns may be observed among attack events of the same attack type. For example, the labels “1” and “2” represent the Blind DoS 505 and BTS DoS 510 attacks, respectively, in which different attack instances of the same type exhibit highly similar group anomaly patterns with respect to the reconstruction errors. This observation also holds for the remaining attack types. As a result, this feature may be potentially useful for training a supervised attack classifier to recognize and cluster events of different attack types based on their reconstruction error patterns. Results indicate that lightweight unsupervised anomaly detection models can detect unseen threat patterns by training on benign cellular traffic. Visualization 500 illustrates the ability of the Autoencoder model to distinguish between expected network behavior and security threats. The graph plots the Sequence Index on the horizontal axis (representing the timeline or order of telemetry sequences) against the reconstruction error magnitude on the vertical axis, which ranges from 0.000 to approximately 0.016. A horizontal line labeled “Detection Threshold” line 515 marks the detection threshold. Data points falling below this line 515 are classified as Benign Traces (normal traffic), while those rising above it are flagged as Attack Traces (anomalies). The visualization 500 highlights two distinct attack modalities detected by the system.

Attack Pattern 1 (Blind DoS) 505 is identified by the number “1” and labeled as Blind Denial of Service (Blind DOS). These anomalies appear as sharp, isolated high-magnitude spikes. Attack Pattern 2 (BTS DoS) 510 is identified by the number “2” and labeled as Base Transceiver Station Denial of Service. These anomalies exhibit a broader, recurring “sawtooth” or oscillating pattern of elevated errors. The comparison in FIG. 5 demonstrates that different attack types can produce distinct error fingerprints, supporting the system's ability to cluster and identify specific threat types based on the shape and duration of the anomaly.

In some embodiments, an evaluation may be performed to determine whether LLMs can explain why a cellular sequence is benign or anomalous, akin to a security analyst. In some embodiments, existing web-based LLMs and zero-shot prompting strategies (i.e., no example provided) may be used.

In some embodiments, the system's efficacy can be validated through comparative evaluations of multiple baseline Large Language Models (LLMs) tasked with analyzing cellular network traffic traces. Rather than relying on a single architecture, a diverse set of foundation models, ranging from proprietary commercial engines to open-source variants, have been tested against a suite of cellular attack scenarios. These scenarios encompass threats such as Base Transceiver Station Denial of Service (BTS DoS), Blind DoS, Uplink and Downlink Identity Extraction, and Null Ciphering attacks, alongside control cases involving benign traffic sequences. Experimental results demonstrate that in the absence of fine-tuning (i.e., in a zero-shot configuration), modern foundation models possess the capability to parse cellular protocol data, distinguish between anomalous and benign traces, and provide accurate natural language explanations for complex network security events. While earlier generations of models exhibited performance variance across specific vectors, for instance, finding subtle Uplink Identity Extraction attacks more challenging than overt Denial of Service attacks, the newer generation models demonstrated high robustness, correctly identifying the vast majority of threat vectors.

The architecture described herein is model-agnostic and designed to scale with the rapid advancement of generative AI technology. As foundation models continue to evolve, achieving higher token limits, superior reasoning capabilities, and more extensive pre-training on technical standards, the accuracy and granularity of the security assessments generated by this system will correspondingly improve. The initial evaluations indicate that current models already serve as effective AI security analysts, capable of successfully validating benign sequences and flagging anomalies. As future iterations of these models reduce hallucination rates and improve context retention, the system's ability to detect elusive or novel zero-day threats (such as complex signaling storms or multi-stage identity thefts) will effectively self-optimize, with little to no changes to the underlying anomaly detection or orchestration framework.

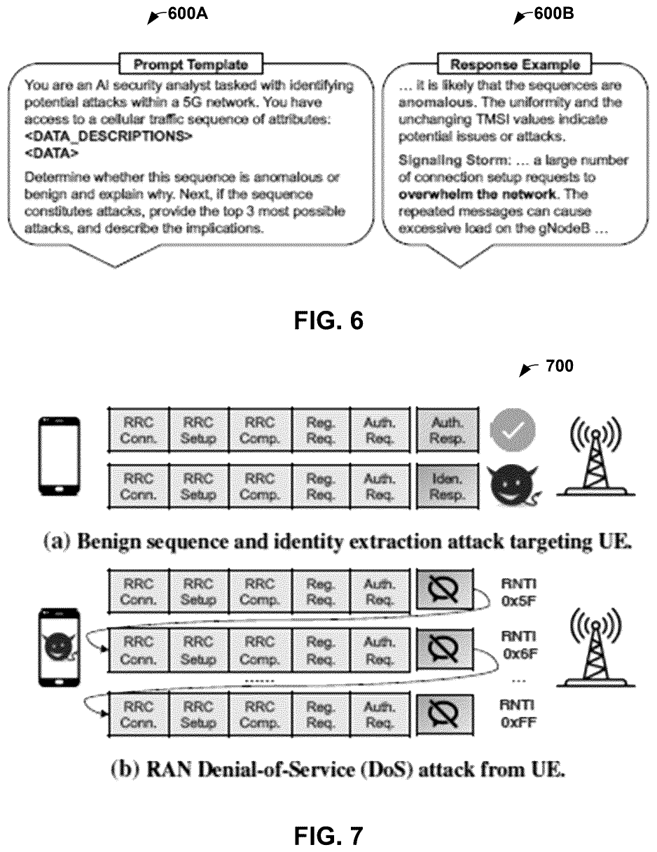

FIG. 6 presents an example prompt template 600A and an example response 600B, in accordance with example embodiments. The Prompt Template 600A demonstrates how the system structures its query to the AI. It begins by establishing a persona: “You are an AI security analyst tasked with identifying potential attacks within a 5G network.” This is followed by placeholders for data context: <DATA_DESCRIPTIONS> and <DATA>, representing the specific telemetry attributes and sequence data being analyzed. The prompt then issues a specific set of instructions. First, to determine if the sequence is anomalous or benign and explain the reasoning, and second, if an attack is detected, to list the “top 3 most possible attacks” and describe their implications.

The Response Example 600B shows a sample output generated by a gen AI model using this template. The gen AI first confirms the anomaly: “it is likely that the sequences are anomalous,” citing specific evidence such as “uniformity and the unchanging Temporary Mobile Subscriber Identity (TMSI) values” as indicators of potential issues. It then proceeds to classify the threat as a Signaling Storm, explaining the cause as “a large number of connection setup requests to overwhelm the network.” Finally, it describes the implication, noting that “repeated messages can cause excessive load on the gNodeB” (the 5G base station). FIG. 6 visually confirms the system's ability to translate raw data into actionable, human-readable security intelligence.

This response shows that the LLM can accurately identify a potential signaling storm (equivalent to BTS DoS) based on the repeated RRC message patterns. For more complicated attacks such as Blind DoS, some base-line LLMs could extract implicit relations (e.g., replayed TMSI numbers in different UE sessions) and thus correctly suggest the attack. LLMs generally fall short in detecting uplink identity extraction attack as they exhibit compliant protocol traces and is thus challenging to distinguish from normal traces. Existing baseline LLM models are promising to classify and explain complex cellular anomalies and attacks with zero-shot prompting.

FIG. 7 illustrates two example cellular attack scenarios 700 targeting the Radio Access Network (RAN) by exploiting unprotected protocol messages between a User Equipment (UE) and the network, in accordance with example embodiments. Scenario (a) includes a Benign Sequence vs. Identity Extraction Attack. The top half of FIG. 7 compares a benign (normal) connection sequence with an Identity Extraction attack. For example, a Benign Sequence illustrated in the top row includes a normal connection flow that involves the UE and base station exchanging messages in a given order: RRC Conn. Request->RRC Setup->RRC Complete->Registration Request->Authentication Request->Authentication Response. This successful sequence is marked with a checkmark.

The bottom row illustrates an attack sequence. In the attack scenario (marked with a devil icon), a Man-in-the-Middle (MitM) adversary intercepts the communication. The sequence proceeds normally until the authentication phase (Auth. Req.). Instead of an example response, the attacker may inject an Identity Response request (or forces an identity request), tricking the UE into transmitting its permanent identity in plain text, thus compromising user privacy.

Scenario (b) includes a RAN Denial-of-Service (DoS) Attack. The bottom half of FIG. 7 depicts a RAN Denial-of-Service (DoS) attack originating from a malicious UE. In the attack pattern, the malicious UE initiates multiple rapid connection attempts in a loop. For an attempt, it completes the RRC handshake (RRC Conn.->Setup->Comp.) and sends a Registration Request and Authentication Request. In some embodiments, instead of completing the authentication (indicated by the null symbol ∅), the UE may abort and restart the process with a new temporary identifier.

In the identifier flooding, the UE cycles through different Radio Network Temporary Identifier (RNTI) values, such as, for example, 0x5F, 0x6F, and 0xFF, for an attempt. This rapid cycling exhausts the base station's available RNTI pool and signaling resources, preventing legitimate users from connecting to the network.

An end-to-end security framework based on the O-RAN architecture is described herein to illustrate how AI can drive cellular networks toward automatic and explainable threat detection and mitigation. As a defense framework deployed on the network side, MOBIWATCH faces challenges in handling various types of cellular threats. These include downlink attacks that drop protocol messages and rogue base stations that directly communicate with user devices. Another limitation is the difficulty in distinguishing between anomalous events and actual attacks. For example, the transmission of a plain-text user identity could indicate either an identity extraction attack or just an unusual network event.

As described herein, foundation models are increasingly capable of generating remedies when provided with abnormal or attack traces. This highlights the potential for cellular networks to perform self-management and control, such as security countermeasure deployment and fault recovery through data plane control primitives such as dApps. The O-RAN E2SM's RAN Control specification defines a set of actions that may be incorporated into the AI pipeline. Reinforcement learning approaches may also be adopted to ensure the network maintains healthy states.

One of the challenges in AI-driven cellular security is the scarcity of data, which prevents many O-RAN solutions and xApps from being deployed in practical networks. Operator-grade data is highly significant but rarely available in practice. Recent development in large-scale cellular testbeds as well as open-sourced cellular stacks and SDR hardware have provided valuable resources to instantiate networks and perform testing. Real-world cellular data also demands more robust models to handle network noise and complex scenarios, which pose additional challenges for anomaly and attack detection.

While baseline LLMs can provide accurate reasoning for cellular network data, these models are known to suffer from various weaknesses such as hallucinations. To address these issues, a Retrieval-Augmented Generation (RAG) may be adapted to augment prompts and/or adapt the pre-trained LLMs to specialized cellular domains (e.g., through fine-tuning), by leveraging accurate cellular protocol knowledge (e.g., those from 3GPP specifications).

### Example Commercial Embodiments

In various commercial embodiments, the disclosed system can be architected as a Software as a Service (SaaS) platform. In this deployment model, the gen AI-driven security framework, comprising the anomaly detection model and the LLM analyzer xApp, may be hosted centrally on a cloud infrastructure (e.g., a public or private cloud) managed by a service provider. Network operators or enterprise tenants can subscribe to the service, accessing the security dashboard and remediation interface via a web-based portal. The underlying RAN telemetry may be securely transmitted from the operator's edge nodes (e.g., via the E2 interface) to the centralized SaaS cloud, where the LMM processing may take place. This model allows network operators to leverage state-of-the-art AI Security Analyst capabilities and not have to rely on the capital expenditure (CapEx) associated with purchasing and maintaining high-end GPU clusters on-premise.

Furthermore, the technology may be commercialized as Machine Learning as a Service (MLaaS). In some embodiments, the system, including the pre-trained unsupervised detection algorithms and the specialized zero-shot prompt templates, may be exposed via RESTful APIs. Third-party developers, system integrators, or other network equipment vendors can send raw telemetry data to the MLaaS endpoint and receive back structured security assessments, anomaly scores, and natural language explanations. This allows the technology to serve as a modular intelligence layer that can be integrated into existing Security Information and Event Management (SIEM) systems or broader orchestration platforms, effectively renting the inference capabilities of the fine-tuned models on a usage-based pricing tier.

In the context of enterprise connectivity and private cellular networks, the system enables a robust Network as a Service (NaaS) offering. Managed Service Providers (MSPs) utilizing this technology can deploy secure-by-design private 5G/6G slices to vertical industries such as manufacturing, logistics, or healthcare. By integrating the automated defense cycle and closed-loop feedback mechanism described herein, the NaaS provider can contractually guarantee stricter Service Level Agreements (SLAs) regarding uptime and data integrity. The system can automatically detect and mitigate threats (e.g., a signaling storm in a factory floor IoT network) before they impact the client's operations, thereby reducing the provider's operational overhead (OpEx) and mitigating the risk of SLA penalty payouts.

### Example Network Environment

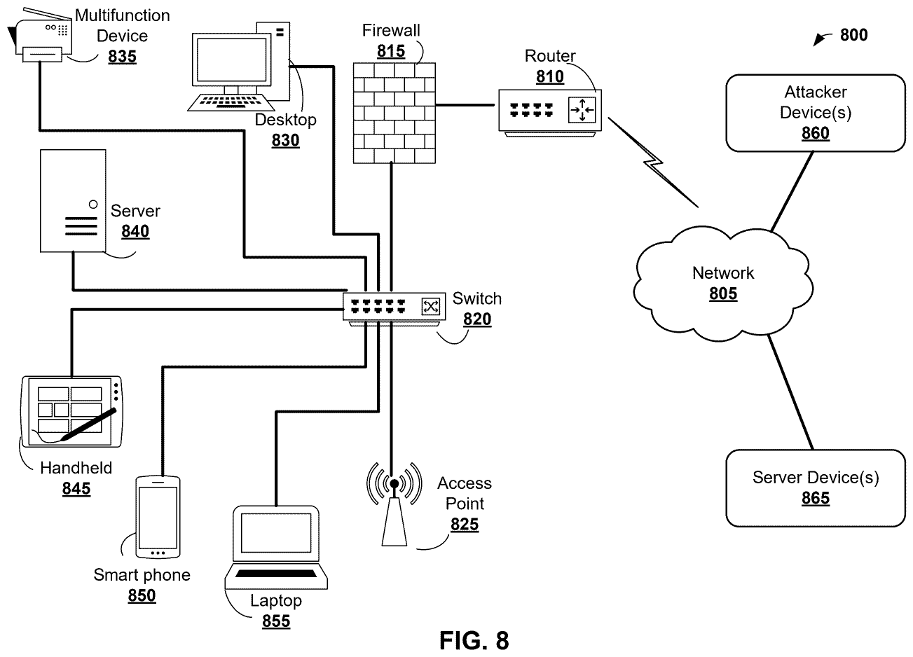

FIG. 8 depicts a network environment 800, in accordance with example embodiments. Network environment 800 includes network 805, attacker device(s) 860, and server device(s) 865, that are configured to communicate, via network 805, with one or more devices such as a desktop 830, a device 835, a server 840, a handheld device 845, a smart phone 850, and/or a laptop 855.

Network 805 may correspond to a local area network (LAN), a wide area network (WAN), a WLAN, a WWAN, a corporate intranet, the public Internet, or any other type of network configured to provide a communications path between networked computing devices. Network 805 may also correspond to a combination of one or more LANs, WANs, corporate intranets, and/or the public Internet.

The network environment 800 may include tens, hundreds, or thousands of devices. In some examples, the one or more devices can be directly connected to network 805. In other examples, the devices can be indirectly connected to network 805 via router 810, firewall 815, network switch 820, and/or access point 825. In this example, router 810, firewall 815, network switch 820, and/or access point 825 can act as an associated computing device to pass electronic communications between the one or more devices and network 805. Although an example physical topology of network 805 is illustrated in FIG. 8, it is understood that network 805 may be associated with a logical topology for data flow between physical components of network 805.

Router 810 can be configured to transmit packets by processing routing information included in a packet (e.g., Internet protocol (IP) data from layer 3). The routing information can be processed via a routing table. Firewall 815 is a network device that can be configured to control network security and access rules. Network switch 820 can be a single switch or an array of switches. Switch 820 is a network device that can be configured to connect various devices on a network, such as, for example, desktop 830, device 835, server 840, handheld device 845, smart phone 850, and/or laptop 855. Switch 820 can use packet switching to receive and forward data between devices in a network. Access point 825 is a network device that can be configured to provide wireless access to various devices on the network.

Server devices 865 can be configured to perform one or more services, as requested by the one or more devices. For example, server device 865 can provide content to the one or more devices. The content can include, but is not limited to, content available over the World Wide Web (WWW), content from a dedicated server, software, images, audio, and/or video. The content can include confidential information. Although server 840 is shown as a single server, it can represent a plurality of servers, and/or a data center comprising a plurality of servers. In some embodiments, attacker device 860 can be a device that performs penetration and intrusion acts that target wireless networks in one or more devices (e.g., network provided by access point 825) to capture and/or intercept information exchanged over the network and/or intrude with the traffic of information.

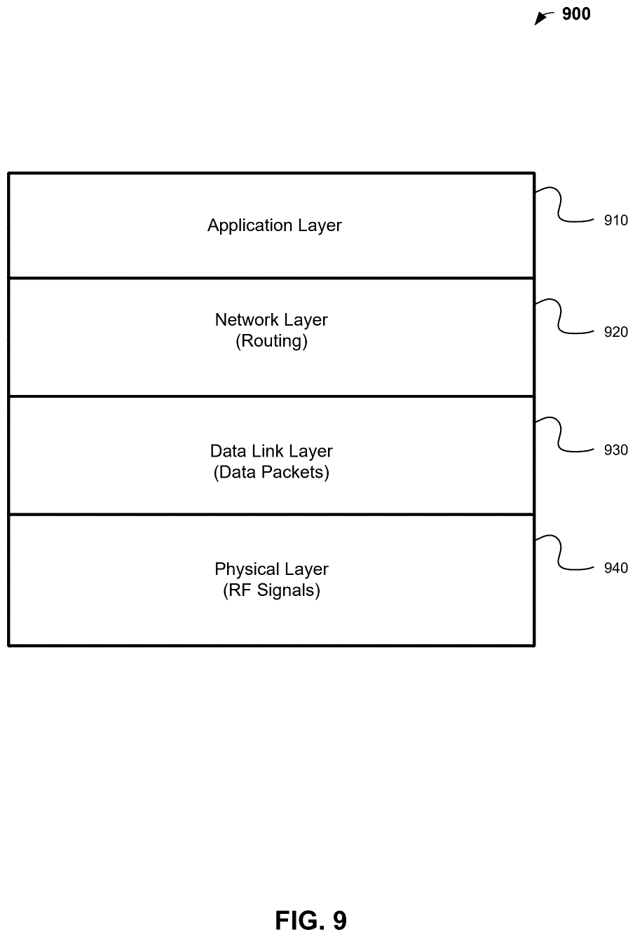

FIG. 9 depicts a protocol stack 900, in accordance with example embodiments. The protocol stack 900 enables nodes in a packet-switched network (e.g., network environment 800) to communicate with one another. The term “node” can refer to any computing device in a network, including wireless access points, wireless devices, etc. Protocols that implement a packet-switched network divide messages into packets before the messages are sent. A packet may include the source, and destination addresses and the data. The packet is then transmitted individually and can follow different routes to its destination. The original message is recompiled at the destination after the packets forming the message arrive.

Network communication among the nodes (and wireless access points) is generally conceptualized in terms of protocol layers, such as the physical layer 940, data link layer 930, network layer 920, and application layers 910, and such protocol layers form a protocol stack 900. In general, the protocol layers exchange control and status information with one another. For a node transmitting a communication, control starts at the application layer 910 and passes layer by layer to the physical layer 940, which sends the communication over a communication link to a receiving node. The receiving node processes the communication, layer by layer, up the stack of protocol layers, starting at the physical layer 940 and ending at the application layer 910. It is to be understood that the protocol stack 900 can have additional protocol layers to those shown, such as a transport layer. The protocol used at the physical layer 940 of the protocol stack 900 accommodates the type of physical medium over which the nodes communicate. The physical layer 940 conveys the bit stream in the radio signal through the network environment 800 at the electrical and mechanical level, and provides the hardware means of sending and receiving data.

In some embodiments, the nodes in network environment 800 communicate with each other over links using an IEEE 802.11 wireless communications standard (e.g., IEEE 802.11(a), IEEE 802.11(b), and IEEE 802.11(g)). Other embodiments of wireless communications standards that can be used by the nodes include BLUETOOTH, HYPERLAN, and HomeRF. For a node operating according to the IEEE 802.11, the physical layer 940 specifies the physical aspects of the radio signaling (e.g., frequency hopping spread spectrum (FHSS), and direct sequence spread spectrum (DSSS)).

The data link layer 930 encodes and decodes data packets into bits and handles errors in the physical layer 940, flow control and frame synchronization. In some embodiments, the data link layer 930 comprises two sub-layers: a Logical Link Control (LLC) layer and a Media Access Control (MAC) layer (the lower of the two sub-layers). The MAC sub-layer controls access to the physical transmission medium; the LLC layer controls frame synchronization, flow control, and error checking. The network (or routing) layer 920 provides a protocol for forwarding and routing packets through the network environment 800, by creating logical paths for transmitting packets from node to node.

### Example Computing Device

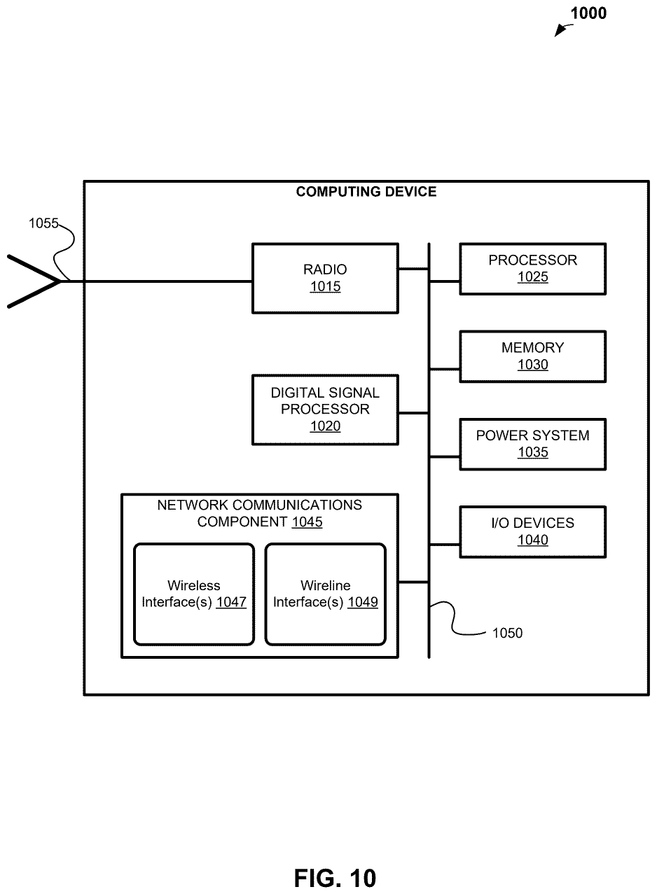

FIG. 10 is a block diagram of an example computing device 1000, in accordance with example embodiments. Computing device 1000 can include a radio 1015, a digital signal processor 1020, one or more processors 1025, memory 1030, power system 1035, input/output devices 1040, and network communications component 1045, which may be linked together via a system bus, network, or other connection mechanism 1050, and an antenna 1055 to communicate with a wireless access point. Computing device 1000 can be one or more of the devices described with reference to FIG. 8 (e.g., desktop 830, a device 835, a server 840, a handheld device 845, a smart phone 850, and/or a laptop 855).

Radio 1015 may be a single physical layer (L1) interface that enables access to wireless media. A software driver can implement Media Access Control (MAC) functionality at layer-2 (L2) of an Open System Interconnect (OSI) standard to instantiate multiple simultaneous virtual network interfaces. Radio 1015 may be coupled to antenna 1055. A Digital Signal Processor (DSP) 1020 may be coupled to the radio 1015 and a Central Processing Unit (e.g., processor 1025). A media access controller (MAC) may be a separate chip or may be integrated into processor 1025.

One or more processors 1025 can include one or more general purpose processors, and/or one or more special purpose processors (e.g., digital signal processors, graphics processing units (GPUs), application specific integrated circuits, etc.). One or more processors 1025 can be configured to execute computer-readable instructions that are contained in memory 1030 and/or other instructions as described herein.

Memory 1030 can include one or more non-transitory computer-readable storage media that can be read and/or accessed by at least one of one or more processors 1025. The one or more computer-readable storage media can include volatile and/or non-volatile storage components, such as optical, magnetic, organic or other memory or disc storage, which can be integrated in whole or in part with at least one of one or more processors 1025. In some examples, memory 1030 can be implemented using a single physical device (e.g., one optical, magnetic, organic or other memory or disc storage unit), while in other examples, memory 1030 can be implemented using two or more physical devices.

Power system 1035 can include one or more batteries and/or one or more external power interfaces for providing electrical power to computing device 1000. One or more external power interfaces of power system 1035 can include one or more wired-power interfaces, such as a USB cable and/or a power cord, that enable wired electrical power connections to one or more power supplies that are external to computing device 1000.

Input/output devices 1040 may include storage devices, a receiver, a transmitter, a speaker, a display, an image capturing component, an audio recording component, a user input device (e.g., a keyboard, a mouse, a microphone), and so forth. Although not shown in FIG. 10, one or more of I/O devices 1040 may be a device external to computing device 1000. Such an external device may communicate with computing device 1000 via a wired or wireless connection, and such communication may be facilitated by an I/O interface of computing device 1000.

A user may enter commands and information into the computing device through input/output devices 1040 such as a keyboard, touchscreen, or software or hardware input buttons, a microphone, a pointing device and/or scrolling input component, such as a mouse, trackball or touch pad. The microphone can cooperate with speech recognition software. These and other input devices are often connected to the processing unit through a user input interface that is coupled to the system bus but can be connected by other interface and bus structures, such as a lighting port, game port, or a universal serial bus (USB). A display monitor or other type of display screen device is also connected to the system bus via an interface, such as a display interface. In addition to the monitor, computing devices may also include other peripheral output devices such as speakers, a vibration device, and other output devices, which may be connected through an output peripheral interface.

The computing device can operate in a networked environment using logical connections to one or more remote computers/client devices, such as a remote computing system. The remote computing system can a personal computer, a mobile computing device, a server, a router, a network PC, a peer device or other common network node, and typically includes many or all of the elements described above relative to the computing device. The logical connections can include a personal area network (PAN) (e.g., Bluetooth®), a local area network (LAN) (e.g., Wi-Fi), and a wide area network (WAN) (e.g., cellular network), but may also include other networks such as a personal area network (e.g., Bluetooth®). Such networking environments are commonplace in offices, enterprise-wide computer networks, intranets and the Internet. A browser application and/or one or more local apps may be resident on the computing device and stored in the memory.

When used in a LAN networking environment, the computing device is connected to the LAN through a network interface, which can be, for example, a Bluetooth® or Wi-Fi adapter. When used in a WAN networking environment (e.g., Internet), the computing device typically includes some means for establishing communications over the WAN. With respect to mobile telecommunication technologies, for example, a radio interface, which can be internal or external, can be connected to the system bus via the network interface, or other appropriate mechanism. In a networked environment, other software depicted relative to the computing device, or portions thereof, may be stored in the remote memory storage device. By way of example, and not limitation, remote application programs as reside on remote computing device. It will be appreciated that the network connections shown are examples and other means of establishing a communications link between the computing devices that may be used.

Network communications component 1045 can include one or more devices that provide one or more wireless interfaces 1047 and/or one or more wireline interfaces 1049 that are configurable to communicate via a network. Wireless interface(s) 1047 can include one or more wireless transmitters, receivers, and/or transceivers, such as a Bluetooth™ transceiver, a Wi-Fi™ transceiver, an LTE™ transceiver, and/or other type of wireless transceiver configurable to communicate via a wireless network. Wireline interface(s) 1049 can include one or more wireline transmitters, receivers, and/or transceivers, such as an Ethernet transceiver, a Universal Serial Bus (USB) transceiver, or similar transceiver configurable to communicate via a physical connection to a wireline network.

Network communications component 1045 can be configured to provide reliable, secured, and/or authenticated communications between various components. For a communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information). Communications can be made secure (e.g., be encoded or encrypted) and/or decrypted/decoded using one or more cryptographic protocols and/or algorithms, such as, but not limited to, a secure sockets protocol such as Secure Sockets Layer (SSL), and/or Transport Layer Security (TLS).

In the context of the specialized security architecture described herein, the computing device 1000 serves as the hardware foundation for the Network Controller (e.g., the Near-RT RIC) or the hosting environment for the AI agents. In some embodiments, the memory 1030 may be configured to store the computer-readable instructions corresponding to the LLM analyzer xApp and/or the unsupervised detection model. The one or more processors 1025 may be utilized to execute these instructions, performing the runtime analysis of the multivariate time-series data to identify deviations from the learned baseline. Furthermore, the network communications component 1045 may be configured to implement the E2 interface, enabling the device to receive the security-aware telemetry reports formatted according to the extended E2SM-KPM service model from the underlying RAN nodes.

In some embodiments, where the Generative AI model (e.g., a Large Multimodal Model or Large Language Model) is hosted locally rather than accessed via an external API, the one or more processors 1025 may include specialized hardware accelerators, such as Graphics Processing Units (GPUs) or Tensor Processing Units (TPUs), optimized for high-dimensional matrix operations. In some embodiments, the input/output devices 1040 may serve as the interface for the human-in-the-loop supervision, displaying the visualization of the reconstruction errors and the natural language security assessment to a security analyst. In the event the computing device 1000 represents a RAN node (such as an O-DU), the radio 1115 and digital signal processor 1120 may be configured to function to intercept and digitize the raw RRC and NAS signaling before it is abstracted into the telemetry stream processed by the security logic.

### Example Methods of Operation

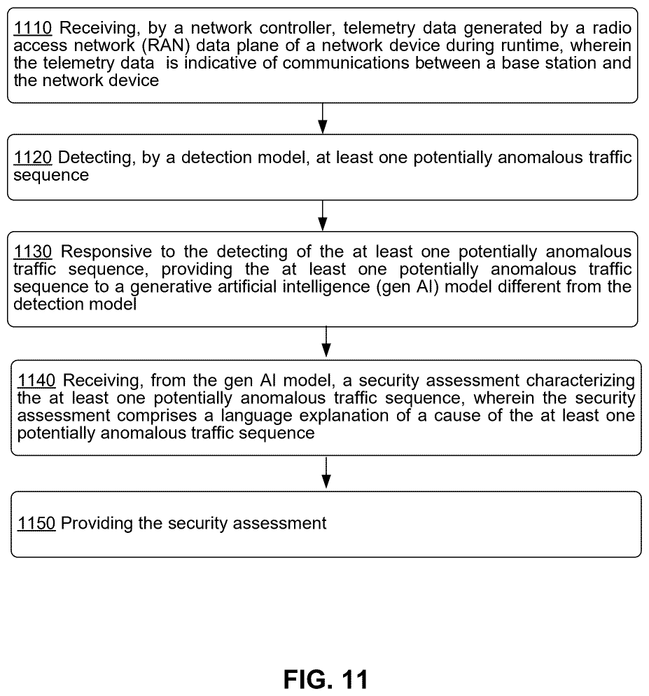

FIG. 11 illustrates an example method 1100 for explainable security in a wireless network, in accordance with example embodiments. Method 1100 may include various blocks or steps. The blocks or steps may be carried out individually or in combination. The blocks or steps may be carried out in any order and/or in series or in parallel. Further, blocks or steps may be omitted or added to method 1100.

The blocks of method 1100 may be carried out by various elements of computing device 1000 as illustrated and described in reference to FIG. 10.

Block 1110 involves receiving, by a network controller, telemetry data generated by a radio access network (RAN) data plane of a network device during runtime, wherein the telemetry data is indicative of communications between a base station and the network device.

Block 1120 involves detecting, by a detection model, at least one potentially anomalous traffic sequence.

Block 1130 involves, responsive to the detecting of the at least one potentially anomalous traffic sequence, providing the at least one potentially anomalous traffic sequence to a generative artificial intelligence (gen AI) model different from the detection model.

Block 1140 involves receiving, from the gen AI model, a security assessment characterizing the at least one potentially anomalous traffic sequence, wherein the security assessment comprises a language explanation of a cause of the at least one potentially anomalous traffic sequence.

Block 1150 involves providing the security assessment.

In some embodiments, the providing of the at least one potentially anomalous traffic sequence to the gen AI model, the receiving of the security assessment, or both, is performed by an autonomous agent configured to orchestrate data flow between the network controller and the gen AI model.

In some embodiments, the providing of the at least one potentially anomalous traffic sequence to the gen AI model involves providing the at least one potentially anomalous traffic sequence in batch mode, wherein a batch comprises a plurality of detected potentially anomalous traffic sequences.

In some embodiments, the providing of the at least one potentially anomalous traffic sequence to the gen AI model involves receiving a user indication to provide the at least one potentially anomalous traffic sequence to the gen AI model. Such embodiments also involve providing the at least one potentially anomalous traffic sequence in response to the user indication.

In some embodiments, the providing of the at least one potentially anomalous traffic sequence to the gen AI model involves providing input to the gen AI model using a zero-shot prompt template.

In some embodiments, the detection model includes an unsupervised deep learning model.

In some embodiments, the unsupervised deep learning model includes one of (1) an unsupervised autoencoder model, or (2) a Long Short Term Memory (LSTM) model configured to detect anomalous sequences when the security-aware telemetry deviates from a predicted next telemetry.

In some embodiments, the detection model is integrated into an xApp.

In some embodiments, the gen AI model includes large language model (LLM) or a large multimodal model (LMM).

In some embodiments, the telemetry data includes security-aware telemetry data.

In some embodiments, the security-aware telemetry includes multivariate time-series data comprising a Radio Resource Control (RRC) message, or a Non-Access-Stratum (NAS) message, or both.

In some embodiments, the telemetry data includes one or more user equipment (UE)-specific parameters. The one or more UE-specific parameters includes Radio Network Temporary Identifier (RNTI), Temporary Mobile Subscriber Identity (S-TMSI), Subscription Permanent Identifier (SUPI), a ciphering algorithm, an integrity algorithm, or a RRC establishment cause.

In some embodiments, the security assessment includes one or more of: (i) classification of an anomaly, (ii) explainability of why the at least one potentially anomalous traffic sequence is anomalous, (iii) causality defining a responsible party, or (iv) remediation steps to mitigate the threat.

In some embodiments, the providing of the security assessment involves providing the security assessment (1) to a closed-loop control feedback mechanism, (2) for human supervision, or (3) both.

In some embodiments, the closed-loop control feedback mechanism may automatically perform one or more of security countermeasure deployment or fault recovery through data plane control primitives.

In some embodiments, the human supervision may be enabled to compare an output of the gen AI model with an output of the detection model to identify a contradiction.

Some embodiments involve determining a consensus between the detection model and the gen AI model. Such embodiments also involve facilitating a security response action when both the detection model and the gen AI model classify the at least one traffic sequence as anomalous.

In some embodiments, the potentially anomalous traffic sequence includes one or more of an attack on the base station, a fault in the RAN, a failure of the RAN, a security threat, a noncompliance by one or more network devices, or a violation of a service level agreement (SLA).

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information and/or comparison of signals can correspond to circuitry that can be configured to perform the specific logical functions of a herein-described method or technique. Alternatively, or additionally, a step or block that represents a processing of information and/or comparison of signals can correspond to a component, a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTML, Java, or other similar languages. Also, an algorithm can be implemented with lines of code in software, configured logic gates in hardware, or a combination of both. In some embodiments, the logic consists of electronic circuits that follow the rules of Boolean Logic, software that contain patterns of instructions, or any combination of both. A module may be implemented in hardware electronic components, software components, and a combination of both.

Generally, application include programs, routines, objects, widgets, plug-ins, and other similar structures that perform particular tasks or implement particular abstract data types. Those skilled in the art can implement the description and/or figures herein as computer-executable instructions, which can be embodied on any form of computing machine-readable media discussed herein.

Many functions performed by electronic hardware components can be duplicated by software emulation. Thus, a software program written to accomplish those same functions can emulate the functionality of the hardware components in input-output circuitry.

The foregoing methods and embodiments thereof have been provided in sufficient detail, but it is not the intention of the applicant(s) for the disclosed system and embodiments provided herein to be limiting. Additional adaptations and/or modifications are possible, and, in broader aspects, these adaptations and/or modifications are also encompassed. Accordingly, departures may be made from the foregoing system and embodiments without departing from the spirit of the system.

This disclosure describes inventive concepts with reference to specific examples. However, the intent is to cover all modifications, equivalents, and alternatives of the inventive concepts that are consistent with this disclosure. It will be apparent, however, to one of ordinary skill in the art that the present approach can be practiced without these specific details. Thus, the specific details set forth are merely exemplary and are not intended to limit what is presently disclosed. The features implemented in one embodiment may be implemented in another embodiment where logically possible. The specific details can be varied from and still be contemplated to be within the spirit and scope of what is being disclosed.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method for explainable security in a wireless network, comprising:
receiving, by a network controller, telemetry data generated by a radio access network (RAN) data plane of a network device during runtime, wherein the telemetry data is indicative of communications between a base station and the network device;
detecting, by a detection model, at least one potentially anomalous traffic sequence;
responsive to the detecting of the at least one potentially anomalous traffic sequence, providing the at least one potentially anomalous traffic sequence to a generative artificial intelligence (gen AI) model different from the detection model;
receiving, from the gen AI model, a security assessment characterizing the at least one potentially anomalous traffic sequence, wherein the security assessment comprises a language explanation of a cause of the at least one potentially anomalous traffic sequence; and
providing the security assessment.

2. The computer-implemented method of claim 1, wherein the providing of the at least one potentially anomalous traffic sequence to the gen AI model, the receiving of the security assessment, or both, is performed by an autonomous agent configured to orchestrate data flow between the network controller and the gen AI model.

3. The computer-implemented method of claim 1, wherein the providing of the at least one potentially anomalous traffic sequence to the gen AI model comprises:
providing the at least one potentially anomalous traffic sequence in batch mode, wherein a batch comprises a plurality of detected potentially anomalous traffic sequences.

4. The computer-implemented method of claim 1, wherein the providing of the at least one potentially anomalous traffic sequence to the gen AI model comprises:
receiving a user indication to provide the at least one potentially anomalous traffic sequence to the gen AI model; and
providing the at least one potentially anomalous traffic sequence in response to the user indication.

5. The computer-implemented method of claim 1, wherein the providing of the at least one potentially anomalous traffic sequence to the gen AI model comprises:
providing input to the gen AI model using a zero-shot prompt template.

6. The computer-implemented method of claim 1, wherein the detection model comprises an unsupervised deep learning model.

7. The computer-implemented method of claim 6, wherein the unsupervised deep learning model comprises one of (1) an unsupervised autoencoder model, or (2) a Long Short Term Memory (LSTM) model configured to detect anomalous sequences when the security-aware telemetry deviates from a predicted next telemetry.

8. The computer-implemented method of claim 1, wherein the detection model is integrated into an xApp.

9. The computer-implemented method of claim 1, wherein the gen AI model comprises a large language model (LLM) or a large multimodal model (LMM).

10. The computer-implemented method of claim 1, wherein the telemetry data comprises security-aware telemetry data.

11. The computer-implemented method of claim 10, wherein the security-aware telemetry comprises multivariate time-series data comprising a Radio Resource Control (RRC) message, or a Non-Access-Stratum (NAS) message, or both.

12. The computer-implemented method of claim 1, wherein the telemetry data comprises one or more user equipment (UE)-specific parameters, and wherein the one or more UE-specific parameters comprises Radio Network Temporary Identifier (RNTI), Temporary Mobile Subscriber Identity (S-TMSI), Subscription Permanent Identifier (SUPI), a ciphering algorithm, an integrity algorithm, or a RRC establishment cause.

13. The computer-implemented method of claim 1, wherein the security assessment comprises one or more of: (i) classification of an anomaly, (ii) explainability of why the at least one potentially anomalous traffic sequence is anomalous, (iii) causality defining a responsible party, or (iv) remediation steps to mitigate the threat.

14. The computer-implemented method of claim 1, wherein the providing of the security assessment comprises:
providing the security assessment (1) to a closed-loop control feedback mechanism, (2) for human supervision, or (3) both.

15. The computer-implemented method of claim 14, wherein the closed-loop control feedback mechanism automatically performs one or more of security countermeasure deployment or fault recovery through data plane control primitives.

16. The computer-implemented method of claim 14, wherein the human supervision is enabled to compare an output of the gen AI model with an output of the detection model to identify a contradiction.

17. The computer-implemented method of claim 1, further comprising:
determining a consensus between the detection model and the gen AI model; and
facilitating a security response action when both the detection model and the gen AI model classify the at least one traffic sequence as anomalous.

18. The computer-implemented method of claim 1, wherein the potentially anomalous traffic sequence comprises one or more of an attack on the base station, a fault in the RAN, a failure of the RAN, a security threat, a noncompliance by one or more network devices, or a violation of a service level agreement (SLA).

19. A system for explainable security in a wireless network, comprising:
a network device configured to receive radio access from a base station;
a network controller communicatively linked to the network device;
one or more processors; and
data storage, wherein the data storage has stored thereon computer-executable instructions that, when executed by the one or more processors, cause the network controller to carry out operations comprising:
receiving, from the network device, telemetry data generated by a radio access network (RAN) data plane during runtime, wherein the telemetry data is indicative of communications between the base station and the network device;
detecting, by a detection model, at least one potentially anomalous traffic sequence;
responsive to the detecting of the at least one potentially anomalous traffic sequence, providing the at least one potentially anomalous traffic sequence to a generative artificial intelligence (gen AI) model different from the detection model;
receiving, from the gen AI model, a security assessment characterizing the at least one potentially anomalous traffic sequence, wherein the security assessment comprises a language explanation of a cause of the at least one potentially anomalous traffic sequence; and
providing the security assessment.

20. A network controller for explainable security in a wireless network, comprising:
a processor; and
a memory storing instructions that, when executed by the processor, cause the network controller to perform operations comprising:
receiving telemetry data generated by a radio access network (RAN) data plane of a network device during runtime, wherein the telemetry data is indicative of communications between a base station and the network device;
detecting, by a detection model, at least one potentially anomalous traffic sequence;
responsive to the detecting of the at least one potentially anomalous traffic sequence, providing the at least one potentially anomalous traffic sequence to a generative artificial intelligence (gen AI) model different from the detection model;
receiving, from the gen AI model, a security assessment characterizing the at least one potentially anomalous traffic sequence, wherein the security assessment comprises a language explanation of a cause of the at least one potentially anomalous traffic sequence; and
providing the security assessment.
